(19) United States
(12) Patent Application Publication
(10) Pub. No.: US 2023/0421414 A1
(43) Pub. Date: Dec. 28, 2023

(54) Adaptive Sounding Reference Signal Mapping for Improved Channel Estimation

(71) Applicant: Google LLC, Mountain View, CA (US)

(72) Inventor: Ming Sun, Mountain View, CA (US)

(73) Assignee: Google LLC, Mountain View, CA (US)

(21) Appl. No.: 18/253,014

(22) PCT Filed: Dec. 24, 2020
(86) PCT No.: PCT/US2020/067040

§ 371 Date: May 15, 2023

(51) Int. Cl. H04L 25/02; H04L 5/00

(52) U.S. Cl. CPC H04L 25/0224; H04L 5/0051

(57) ABSTRACT

The present disclosure describes various aspects of adaptive sounding reference signal mapping that a user equipment (UE) implements to improve channel estimation. In aspects, a set of sounding reference signal (SRS) symbols are generated that include at least first and second SRS symbols. An offset for the second SRS symbol is determined based on a difference between a first radio chain and a second radio chain of the UE. The first and second SRS symbols are then mapped to an antenna port of the first radio chain. The UE transmits the first SRS symbol to a base station via the antenna port of the first radio chain and transmits the second SRS symbol to the base station via the antenna port of the first radio chain while the offset is applied to the first radio chain. By so doing, the UE may improve channel estimation for uplink and/or downlink communications.

### BACKGROUND

Many electronic devices enable users to communicate with other devices and access resources via wireless networks. Wireless networks are typically provided through, and administered by, base stations of the wireless network. To communicate over the wireless network, a mobile station establishes a connection with one of the base stations to receive downlink or transmit uplink information (e.g., control signaling or data). At a physical level, this information is communicated as respective signals transmitted by the mobile station or base station through a channel of a wireless communication environment.

To enable respective transmitter configuration, the mobile station typically uses a sounding channel by which reference signals are transmitted to the base station, which estimates characteristics of the channel between the base station and mobile station for wireless communication. To do so, the mobile station transmits reference signals via transmit chains that are connected to respective antennas of the mobile station. Due to the costs and complexity associated with switching transmit chains of the mobile station between antennas, however, most mobile stations are capable of transmitting reference signals through one or two respective antennas. As such, the transmit chain switching configuration of the mobile station may restrict a number of reference signals that the mobile station can transmit (e.g., two reference signals), which may in turn limit the accuracy with which the base station is able to estimate the channel for wireless communication.

### SUMMARY

This disclosure describes apparatuses of and techniques for adaptive sounding reference signal mapping for improved channel estimation. In various aspects, a user equipment (UE) generates a set of sounding reference signal (SRS) symbols that include at least first and second SRS symbols (e.g., two SRS symbols of a sequence of four SRS symbols). An offset for the second SRS symbol is determined based on a difference between a first radio chain and a second radio chain of the UE. The first SRS symbol and second SRS symbol (e.g., offset SRS symbol) are then mapped to an antenna port (e.g., physical antenna port) of the first radio chain of the UE. The UE transmits the first SRS symbol to a base station via the antenna port of the first radio chain of the UE and transmits the second SRS symbol to the base station via the antenna port of the first radio chain while the offset applied to the first radio chain. Based on channel information determined from the at least two SRS symbols, the UE communicates uplink or downlink signaling or information with the base station. By so doing, the UE may improve channel estimation for uplink and/or downlink communications, which may in turn enable increased communication throughput between the UE and the base station.

In some aspects, a method for adaptive sounding reference signal mapping performed by a user equipment (UE) comprises generating a set of sounding reference signal (SRS) symbols that include at least a first SRS symbol and a second SRS symbol. An offset for the second SRS symbol is determined based on a difference between a first radio chain of the UE and a second radio chain of the UE. The first SRS symbol and the second SRS symbol are mapped to an antenna port of the first radio chain of the UE. The UE transmits the first SRS symbol to a base station via the antenna port of the first antenna chain and then applies the offset for the second SRS symbol to the first radio chain. The UE transmits the second SRS symbol to the base station via the antenna port of the first radio chain with the offset applied to the first radio chain. The UE and base station can then communicate based on channel state information determined using the at least first SRS symbol and the second SRS symbol.

In other aspects, a method to implement adaptive sounding reference signal mapping using multiple radio chains of a user equipment comprises generating a sequence of sounding reference signal (SRS) symbols that correspond to four respective antennas of the multiple radio chains, the four respective antennas including at least a first antenna, a second antenna, a third antenna, and a fourth antenna. A first offset is determined for a third of the SRS symbols based on a difference between a first radio chain of the first antenna and a third radio chain of the third antenna. A second offset is determined for a fourth SRS symbol based on a difference between a second radio chain of the second antenna and a fourth radio chain of the fourth antenna. A first of the SRS symbols and the third SRS symbol are mapped to the first radio chain of the first antenna and a second of the SRS symbols and the fourth SRS symbol are mapped to the second radio chain of the second antenna. The UE transmits the first SRS symbol to a base station via the first radio chain of the first antenna and transmits the second SRS symbol to the base station via the second radio chain of the second antenna. The first offset is then applied to the first radio chain of the first antenna, and the second offset is applied to the second radio chain of the second antenna. The UE then transmits the third SRS symbol to the base station via the first antenna of the first radio chain while the first offset is applied to the first radio chain; and transmits the fourth SRS symbol to the base station via the second antenna of the second radio chain while the second offset is applied.

In yet other aspects, a method to enable a user equipment to perform adaptive sounding reference signal mapping comprises characterizing radio chains for multiple antennas of the user equipment (UE) to provide respective radio chain information. The method then assigns an antenna of a receive-only radio chain to an antenna of a transmit capable radio chain based on the respective radio chain information. An offset between the receive-only radio chain and the transmit capable radio chain is determined based on the respective radio chain information. The offset information is then stored to a memory of the UE to enable mapping of sounding reference signal symbols from the antenna of the receive-only radio chain to the antenna of the transmit capable radio chain.

The details of one or more implementations of adaptive sounding reference signal mapping for improved channel estimation are set forth in the accompanying drawings and the following description. Other features and advantages will be apparent from the description and drawings, and from the claims. This Summary is provided to introduce subject matter that is further described in the Detailed Description and Drawings. Accordingly, this Summary should not be considered to describe essential features nor used to limit the scope of the subject matter of the appended claims.

### BRIEF DESCRIPTION OF THE DRAWINGS

This disclosure describes apparatuses and techniques of adaptive sounding reference signal mapping for improved channel estimation with reference to the following drawings. The use of same or similar reference numbers throughout the description and the figures may indicate like features or components:

FIG. 1 illustrates an example operating environment in which various aspects of adaptive sounding reference signal mapping can be implemented;

FIG. 2 illustrates an example device diagram of network entities that can implement various aspects of adaptive sounding reference signal mapping;

FIG. 3 illustrates an example configuration of components for implementing adaptive sounding reference signal mapping in accordance with one or more aspects;

FIG. 4 illustrates an example antenna port mapping for transmitting sounding reference signal symbols in accordance with one or more aspects;

FIG. 5 illustrates an example wireless network environment in which a user equipment can transmit sounding reference signals to a base station in accordance with one or more aspects;

FIG. 6 illustrates examples of a resource grid of time and frequency resources and time slots in which sounding reference signal symbols can be mapped in accordance with one or more aspects;

FIG. 7 illustrates another example of a resource grid of time and frequency resources in which sounding reference signal symbols can be mapped in accordance with one or more aspects;

FIG. 8 illustrates an example control and signaling diagram for implementing adaptive mapping of sounding reference signals in accordance with one or more aspects;

FIG. 9 illustrates an example method for adaptive sounding reference signal mapping in accordance with one or more aspects;

FIG. 10 illustrates an example method for mapping offset sounding reference signal symbols to respective antennas in accordance with one or more aspects;

FIGS. 11A and 11B illustrate an example method for enabling a user equipment to perform aspects of adaptive sounding reference signal mapping;

FIG. 12 depicts an example graph of improved throughput performance of a user equipment provided by adaptive sounding reference signal mapping in accordance with the described aspects;

FIG. 13 illustrates an example electronic device that may implement techniques of adaptive sounding reference signal mapping in accordance with one or more aspects;

FIG. 14 illustrates an example system-on-chip (SoC) environment in which techniques of adaptive sounding reference signal mapping may be implemented; and

FIG. 15 illustrates an example configuration of a wireless communication processor that may implement various aspects of adaptive sounding reference signal mapping.

### DETAILED DESCRIPTION

Preceding techniques for estimating communication channels are typically limited by a hardware configuration of a user equipment (UE) that transmits channel sounding signals to a base station. Generally, the base station can use channel sounding signals transmitted by the UE to estimate the communication channel, from which the base station determines configurations (e.g., beamforming and precoding configurations) for transmitting downlink communications to the UE. Due to asymmetric receive and transmit path configurations of most UEs, however, the accuracy with which the base station estimates the communication channel may be limited relative to a number of antennas supported by the UE. For example, a UE may include multiple antennas (e.g., four antennas) and hardware for receiving multiple-input multiple-output (MIMO) or implementing high-order receive diversity (HORxD) modes yet may only support transmission via a few antennas (e.g., two antennas) due to cost and space limitations associated with transmitter and antenna switching circuitry. Thus, despite having multiple antennas for improving reception of downlink communications from the base station, the UE may only be capable of transmitting channel sounding signals through one or two transmit antennas. Without channel sounding signals from the respective receive antennas, the channel estimation accuracy of the base station is limited to the uplink paths of the UE transmit antennas. As such, the downlink transmit configurations of the base station, which are determined based on the sounding signal uplink paths, are often less than optimal and may result in reduced downlink data throughput to the UE.

In contrast with the preceding techniques, the present disclosure describes aspects of adaptive sounding reference signal mapping for improved channel estimation. Generally, the described aspects enable a UE to implement adaptive channel sounding procedures in which the UE can approximate transmission of additional sounding reference signal (SRS) symbols from antennas (e.g., receive-only antennas) that are not coupled to transmit chains of the UE to improve channel estimation. In other words, the UE can leverage mapping of the SRS symbols to resources of an air interface that correspond to the receive-only antennas and apply an offset to a transmit chain coupled to a different antenna such that the UE enables sounding of another uplink path to the base station. By so doing, the additional SRS symbols that approximate different uplink paths may enable the base station to estimate characteristics of a communication channel with more accuracy, which enable more-precise downlink channel configurations and increased downlink throughput to the UE.

By way of review, a UE may transmit one SRS symbol from each antenna as part of a channel estimation process in which the base station estimates the channel quality corresponding to each communication path when a multiple antenna scheme is implemented for communication between the UE and base station. As described in relation to adaptive sounding reference signal mapping, however, the SRS symbols or corresponding SRS ports are not necessarily mapped directly to each physical antenna of the UE. In other words, the SRS symbols are mapped on different sub carriers of an air interface resource grid for different ones of the UE antennas to reduce interference. Further, there are various SRS configurations that a UE may implement based on UE hardware and sounding procedure requests by a base station.

These SRS configurations generally include 1T2R, 1T4R, 2T2R, 2T4R, or T=R, where “T” represents viable antenna ports of transmit chains (Tx antennas or transmit-capable radio chains), and “R” represents viable antenna ports of receive chains (Rx antennas or receive-only radio chains). In the context of various SRS symbol transmission and UE configurations, 1T2R is one Tx chain that can send SRS symbols through two receiving antennas, 1T4R is one Tx chain that can send SRS symbols through four receiving antennas, 2T2R is two Tx chains that can send SRS symbols through two receiving antennas, and 2T4R is two Tx chains that can send SRS symbols through four receiving antennas. As such, to sound four different communication channels using the preceding techniques, a UE must include antenna switching circuitry that physically couples one or two transmit chains to all four receive antennas of the UE. As described above, adding such antenna switching circuitry (e.g., supporting 1T4R or 2T4R switch circuits) to a UE can be prohibitively expensive in terms of cost and PCB design space, particularly to cover all combinations of frequency bands. Additionally, path loss associated with the additional switching circuitry (e.g., cumulative insertion loss throughout an RF front end) may also impair RF performance such that little if any gain is achieved by adding the additional switching circuitry for additional transmit radio paths.

To address these and other issues, the described aspects of adaptive sounding reference signal mapping enable a UE to realize approximate channel sounding for more communication paths than the UE can physically use for uplink transmission. For example, in accordance with one or more aspects, a UE can realize 1T4R channel estimation with a 1T2R hardware configuration or use a 2T2R hardware configuration to realize a 2T4R channel estimation. To do so, a UE may leverage the fact that a mapping of SRS symbols or SRS transmission ports by the UE is not explicitly visible to a receiving base station of the network, instead these symbols or ports are seen by the base station as an integrated part of an overall communication channel. By way of example, the base station can request that a UE transmit a set of four SRS symbols for sounding a communication channel and then determine, based on an adaptive sounding through two antennas, a configuration (e.g., precoder matrix) for uplink transmissions or a configuration (e.g., beamforming pattern) for downlink transmissions through the communication channel.

To enable adaptive mapping of sounding reference signals, a UE may characterize differences between its transmit and receive radio paths, such as by measuring and recording receive performance metrics between first/third radio paths and second/fourth radio paths. Based on these performance metrics, the UE can determine respective offsets between the transmit radio paths (e.g., first and second radio paths) and the receive radio paths (e.g., third and fourth radio paths). During a channel sounding procedure, the UE manages mapping of SRS symbols for all of the antennas over the SRS transmit antenna ports. To illustrate, the UE generates a set of SRS symbols and transmits first and second SRS symbols via the respective antenna ports of the first and second radio paths. The UE then applies the offsets for the third and fourth SRS symbols by adjusting respective path gains of the first and second radio chains. While the offsets are applied, the UE sends the third and fourth SRS symbols via the respective antenna ports of the first and second radio paths effective to approximate channel sounding for the third and fourth radio paths. By so doing, the UE can reduce the channel estimation errors due to the parametric delta between the primary/secondary and third/fourth radio paths. In some cases, the resulting channel estimates provided by the described aspects that approximate a 1T4R or 2T4R channel sounding are effective to increase downlink throughput to the UE by as much as 15% over a 1T2R channel sounding. These are but a few examples of adaptive sounding reference signal mapping to improve channel estimation, others of which are described throughout the disclosure.

In various aspects, a user equipment (UE) generates a set of sounding reference signal (SRS) symbols that include at least first and second SRS symbols (e.g., two SRS symbols of a sequence of four SRS symbols). An offset for the second SRS symbol is determined based on a difference between a first radio chain and a second radio chain of the UE. The first SRS symbol and second SRS symbol (e.g., offset SRS symbol) are then mapped to an antenna port (e.g., physical antenna port) of the first radio chain of the UE. The UE transmits the first SRS symbol to a base station via the antenna port of the first radio chain of the UE and transmits the second SRS symbol to the base station via the antenna port of the first radio chain while the offset applied to the first radio chain. In some cases, the UE implements similar operations for a third SRS symbol and a fourth SRS symbol via the first radio chain or a third radio chain, which may be effective to approximate 1T4R or 2T4R channel sounding. Based on channel information determined from the at least two SRS symbols, the UE communicates uplink or downlink signaling or information with the base station. By so doing, the UE may improve channel estimation for uplink and/or downlink communications, which may in turn enable increased communication throughput between the UE and the base station.

The following discussion describes an operating environment, techniques that may be employed in the operating environment, and various devices or systems in which components of the operating environment can be embodied. In the context of the present disclosure, reference is made to the operating environment by way of example only.

### Example Environment

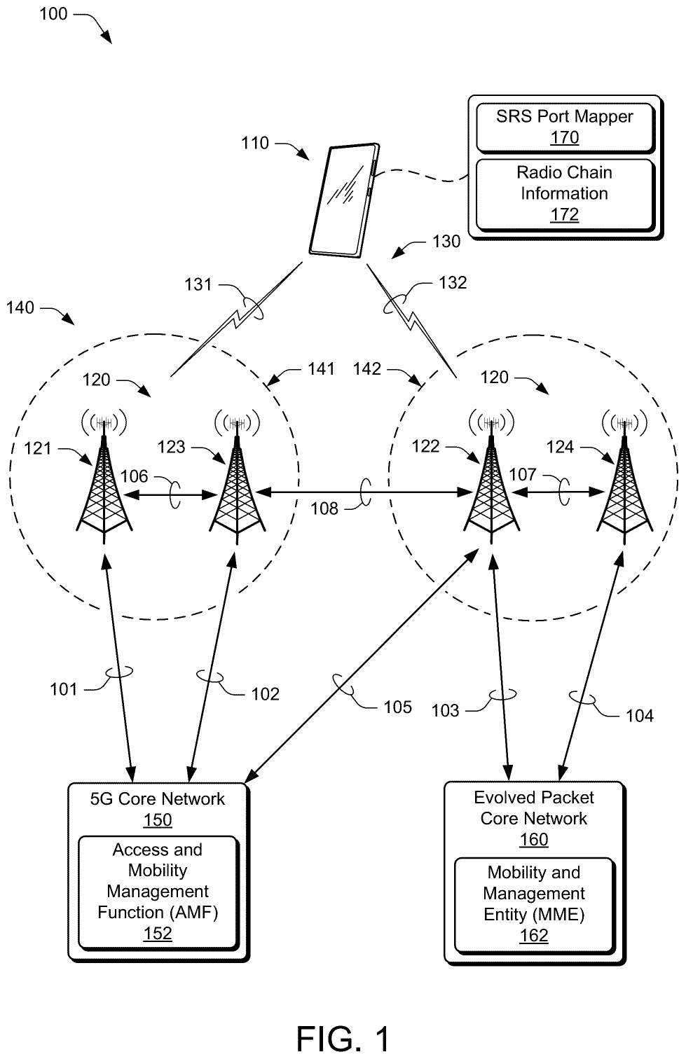

FIG. 1 illustrates an example operating environment 100 in which various aspects of adaptive sounding reference signal (SRS) mapping for improved channel estimation can be implemented. Generally, the example environment 100 includes a user equipment 110 (UE 110), which can communicate with base stations 120 (illustrated as base stations 121, 122, 123, and 124) through wireless communication links 130 (e.g., wireless links or radio links), illustrated as wireless link 131 and wireless link 132. For simplicity, the UE 110 is implemented as a smart-phone but may be implemented as any suitable computing or electronic device, such as a smart watch, mobile communication device, modem, cellular phone, gaming device, navigation device, media device, laptop computer, desktop computer, tablet computer, smart appliance, vehicle-based communication system, an Internet-of-things (IoT) device (e.g., sensor node, controller/actuator node, combination thereof), and the like. The base stations 120 (e.g., an Evolved Universal Terrestrial Radio Access Network Node B, E-UTRAN Node B, evolved Node B, eNodeB, eNB, Next Generation Node B, gNode B, gNB, or the like) may be implemented in a macrocell, microcell, small cell, picocell, or the like, or any combination thereof.

The base stations 120 communicate with the UE 110 through the wireless links 131 and 132 (e.g., radio links or wireless channels), which may be implemented as any suitable type of wireless link. The wireless links 131 and 132 include control and data communication, such as downlink of data and control information communicated from the base stations 120 to the UE 110, uplink of other data and control information communicated from the UE 110 to the base stations 120, or both. The wireless links 130 may include one or more wireless links (e.g., radio links) or bearers implemented using any suitable communication protocol or standard, or combination of communication protocols or standards, such as 3rd Generation Partnership Project Long-Term Evolution (3GPP LTE), LTE-Advanced, Fifth Generation New Radio (5G NR), Sixth Generation (6G), and so forth. Multiple wireless links 130 may be aggregated in a carrier aggregation (CA) to provide a higher data rate for the UE 110. Multiple wireless links 130 from multiple base stations 120 may be configured for Coordinated Multipoint (CoMP) communication with the UE 110. Additionally, multiple wireless links 130 may be configured for dual connectivity (DC) (e.g., dual carrier or multi-carrier), single-RAT dual connectivity (SR-DC), or multi-RAT dual connectivity (MR-DC).

The base stations 120 collectively form a Radio Access Network 140 (e.g., RAN, Evolved Universal Terrestrial Radio Access Network, E-UTRAN, 5G NR RAN or NR RAN). The RANs 140 are illustrated as an NR RAN 141 and an E-UTRAN 142. The base stations 121 and 123 in the NR RAN 141 are connected to a Fifth Generation Core 150 (5GC 150) network. The base stations 122 and 124 in the E-UTRAN 142 connect to an Evolved Packet Core 160 (EPC 160). Alternatively or additionally, the base station 122 may connect to both the 5GC 150 and EPC 160 networks.

The base stations 121 and 123 connect, at 101 and 102 respectively, to the 5GC 150 through an NG2 interface for control-plane signaling and using an NG3 interface for user-plane data communications. The base stations 122 and 124 connect, at 103 and 104 respectively, to the EPC 160 using an S1 interface for control-plane signaling and user-plane data communications. Optionally or additionally, if the base station 122 connects to the 5GC 150 and EPC 160 networks, the base station 122 connects to the 5GC 150 using an NG2 interface for control-plane signaling and through an NG3 interface for user-plane data communications, at 105.

In addition to connections to core networks, the base stations 120 may communicate with each other. For example, the base stations 121 and 123 communicate through an Xn interface at 106 and the base stations 122 and 124 communicate through an X2 interface at 107 to exchange user-plane and control-plane data. The interface or link at 105 or 106 between the base stations 120 can be implemented as any suitable type of link, such as a mmWave link, a sub-mmWave link, or a free-space optical (FSO) link. At least one base station 120 (base station 121 and/or base station 123) in the NR RAN 141 can communicate with at least one base station 120 (base station 122 and/or base station 124) in the E-UTRAN 142 using an Xn interface 107. In aspects, base stations 120 in different RANs (e.g., base stations 120 of each RAN) communicate with one another using an Xn interface such as Xn interface 108.

The 5GC 150 includes an Access and Mobility Management Function 152 (AMF 152), which provides control-plane functions, such as registration and authentication of multiple UE 110, authorization, and mobility management in the 5G NR network. The EPC 160 includes a Mobility Management Entity 162 (MME 162), which provides control-plane functions, such as registration and authentication of multiple UE 110, authorization, or mobility management in the E-UTRA network. The AMF 152 and the MME 162 communicate with the base stations 120 in the RANs 140 and also communicate with multiple UE 110, using the base stations 120.

With reference to FIG. 1, the UE 110 also includes a sounding reference signal port mapper 170 (SRS port mapper 170) and radio chain information 172 in accordance with one or more aspects. Generally, the SRS port mapper 170 may modify UE capability messages, determine offset information for radio chains, map SRS ports or SRS symbols to physical antenna ports of the UE 110, apply offsets to transmit radio chains, manage transmission of SRS symbols, or the like. In some aspects, the SRS port mapper 170 determines an offset based on a difference between a first radio chain and a second radio chain of the UE 110. The UE 110 may store this offset and other radio chain information (e.g., reference information or measurements) as radio chain information 172. As part of a channel sounding procedure, the SRS port mapper 170 can map respective first and second SRS symbols for the first radio chain and the second radio chain to an antenna port of the first radio chain. The UE 110 then transmits a first SRS symbol via the antenna port of the first radio chain. The SRS port mapper 170 then applies the offset to the first radio chain, which can be effective to account for the difference between the first radio chain and second radio chain. While the offset is applied, the UE 110 transmits the second SRS symbol via the antenna port of the first radio chain.

Alternatively or additionally, the SRS port mapper 170 may implement similar operations for a third radio chain and a fourth radio chain of the UE 110 to enable the transmission of two SRS symbols via the antenna port of the third radio chain. This may be effective to approximate channel sounding procedures that include SRS symbols for radio chains of the UE 110 that are not capable of transmitting (e.g., receive-only radio chains). By so doing, the SRS port mapper 170 may enable a base station to estimate a channel with increased accuracy when using at least the first and second SRS symbols transmitted via the antenna port of the first radio chain. The uses and implementations of the SRS port mapper 170 may vary in accordance with one or more aspects and are described throughout the disclosure.

### Example Devices

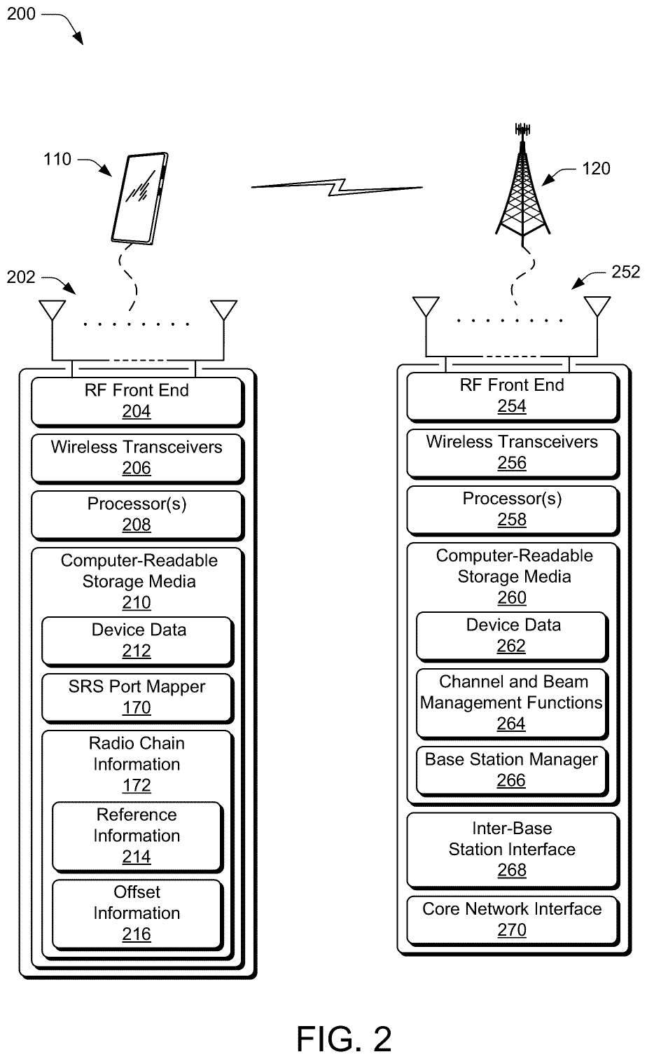

FIG. 2 illustrates an example device diagram 200 of a user equipment and a service cell base station. Generally, the device diagram 200 describes network entities that can implement various aspects of adaptive sounding reference signal mapping for improved channel estimation. FIG. 2 shows respective instances of the UE 110 and the base stations 120. The UE 110 and the base stations 120 may include additional functions and interfaces that are omitted from FIG. 2 for the sake of visual brevity. The UE 110 includes antennas 202, a radio frequency front end 204 (RF front end 204), and wireless transceivers 206 (e.g., an LTE transceiver, 5G NR transceiver, or 6G transceiver) for communicating with base stations 120 in the NR RAN 141 and/or the E-UTRAN 142. The UE 110 may also include one or more additional transceivers (e.g., local wireless network transceiver) for communicating over one or more local wireless networks (e.g., WLAN, WPAN, Bluetooth™, NFC, Wi-Fi-Direct, IEEE 802.15.4, ZigBee, Thread, mmWave, sub-mmWave, FSO, radar, lidar, sonar, ultrasonic) with another UE or local network entities. The RF front end 204 of the UE 110 can couple or connect one or more of the wireless transceivers 206 of the UE 110 to the antennas 202 to facilitate various types of wireless communication.

The antennas 202 of the UE 110 may include an array of multiple antennas that are configured similarly to or differently from each other. The antennas 202 and the RF front end 204 can be tuned to, and/or be tunable to, one or more frequency bands defined by the 3GPP LTE, NR, or 6G communication standards and implemented by the wireless transceivers 206. Additionally, the antennas 202, the RF front end 204, the wireless transceivers 206 (e.g., 5G NR transceiver) may be configured to support beamforming for the transmission and reception of communications with the base stations 120. By way of example and not limitation, the antennas 202 and the RF front end 204 can be implemented for operation in sub-gigahertz bands, sub-6 GHz bands, and/or above 6 GHz bands that are defined by the 3GPP LTE and 5G NR communication standards (e.g., 57-64 GHz, 28 GHz, 38 GHz, 71 GHz, 81 GHz, or 92 GHz bands). In addition, the RF front end 204 can be tuned to, and/or be tunable to, one or more frequency bands defined and implemented by the local wireless network transceivers of the UE 110 to support transmission and reception of communications with other UEs or entities associated with a local wireless network.

The UE 110 may also include sensors (not shown), which can be implemented to detect various environmental or system properties of the UE 110 such as temperature, location, orientation, supplied power, power usage, battery state, or the like. As such, the sensors of the UE 110 may include any one or a combination of temperature sensors, global navigational satellite system (GNSS) sensors, accelerometers, thermistors, battery sensors, and power usage sensors.

The UE 110 also includes processor(s) 208 and computer-readable storage media 210 (CRM 210). The processor 208 may be a single core processor or a multiple core processor implemented with a homogenous or heterogenous core structure. The processor 208 may include a hardware-based processor implemented as hardware-based logic, circuitry, processing cores, or the like. In some aspects, functionalities of the processor 208 and other components of the UE 110 are provided via an integrated processing, communication, and/or control system (e.g., system-on-chip), which may enable various operations of a UE 110 in which the system is embodied. The computer-readable storage media described herein excludes propagating signals. The CRM 210 may include any suitable memory or storage device such as random-access memory (RAM), static RAM (SRAM), dynamic RAM (DRAM), non-volatile RAM (NVRAM), read-only memory (ROM), or Flash memory useable to store device data 212 of the UE 110. The device data 212 includes user data, multimedia data, beamforming codebooks, applications, and/or an operating system of the UE 110, which are executable by processor(s) 208 to enable user-plane communication, control-plane signaling, and user interaction with the UE 110.

In aspects of adaptive sounding reference signal mapping, the CRM 210 of the UE 110 may also include an instance of the SRS port mapper 170 and an instance of the radio chain information 172. Generally, the radio chain information 172 can include information relating to performance metrics or characteristics of radio chains or radio paths of the wireless transceivers 206, RF front end 204, and/or antennas 202 of the UE 110. In this example, the radio chain information 172 includes reference information 214 and offset information 216 for one or more radio chains of the UE 110. The reference information 214 may include respective measurement, calibration, or performance information (e.g., total isotropic sensitivity (TIS)) for one or more radio chains or communication paths of the UE 110. The offset information 216 may include offset information indicative of a difference between any two radio chains, which may include differences in respective reference information 214 for two radio chains. For example, the offset information 216 may indicate, for any two radio chains or communication paths, a difference in receive sensitivity, RF path loss, transmit power, and so forth.

Alternatively or additionally, the SRS port mapper 170 may be implemented in whole or part as hardware logic or circuitry integrated with or separate from other components of the UE 110. Generally, the SRS port mapper 170 of the UE 110 can characterize differences between a first radio chain (e.g., transmit-capable) and a second radio chain (e.g., receive-only) of the UE and determine, based on the differences, offsets for the radio chains that enable the first radio chain to approximate the performance of the second radio chain. The SRS port mapper 170 may then map respective SRS symbols for the first and second radio chains to an antenna port of the first radio chain. After transmitting a first SRS symbol to a base station via the first radio chain, the SRS port mapper 170 applies the offset to the first radio chain and transmits a second SRS symbol to the base station via the antenna port of the first radio chain while the offset is applied. By so doing, the SRS port mapper 170 enables the base station to estimate, based on the first and second SRS symbols, a communication channel between the UE 110 and base station with more accuracy than by transmitting only one SRS symbol via antenna port of the first radio chain. Alternatively or additionally, the SRS port mapper 170 may edit or modify the UE capabilities (not shown) to indicate to a base station 120 that the UE 110 supports channel sounding procedures with more antennas (e.g., four antennas for 1T4R or 2T4R sounding) than those of the UE that are capable of transmitting SRS symbols (e.g., two antennas for 1T2R or 2T2R based on the UE's actual hardware configuration). The implementations and uses of the SRS port mapper 170 of the UE 110 vary and are described throughout the disclosure.

Aspects and functionalities of the UE 110 may be managed by operating system controls presented through an application programming interface (API, not shown). In some aspects, the SRS port mapper 170 accesses an API or an API service of the UE 110 to control aspects and functionalities of the user equipment or transceivers thereof. For example, the SRS port mapper 170 can access or utilize the wireless transceivers 206 to modify transceiver (e.g., modem or radio) configuration information, UE capability information, calibration information, signal quality measurement, or the like. The CRM 210 also includes a communication manager (not shown). The communication manager may also be implemented in whole or part as hardware logic or circuitry integrated with or separate from other components of the UE 110. In at least some aspects, the communication manager configures the RF front end 204, the wireless transceivers 206, and/or other transceivers of the UE 110 to implement the techniques of adaptive sounding reference signal mapping for improved channel estimation as described herein.

As shown in FIG. 2, the device diagram for the base stations 120 includes a single network node (e.g., a gNode B or eNode B). The functionality of the base stations 120 may be distributed across multiple network nodes or devices and may be distributed in any fashion suitable to perform the functions described herein. The base stations 120 include antennas 252, a radio frequency front end 254 (RF front end 254), one or more wireless transceivers 256 (e.g., LTE transceivers, 5G NR transceivers, or 6G transceivers) for communicating with the UE 110. The RF front end 254 of the base stations 120 can couple or connect the wireless transceivers 256 to the antennas 252 to facilitate various types of wireless communication. The antennas 252 of the base stations 120 may include an array of multiple antennas that are configured similar to or differently from each other. The antennas 252 and the RF front end 254 can be tuned to, and/or be tunable to, one or more frequency bands defined by the 3GPP LTE, 5G NR, or 6G communication standards, and implemented by the wireless transceivers 256. Additionally, the antennas 252, the RF front end 254, and/or the wireless transceivers 256 may be configured to support beamforming, such as Massive-MTh/TO, for the transmission and reception of communications with any UE 110 in a network cell provided by the base station.

The base stations 120 also include processor(s) 258 and computer-readable storage media 260 (CRM 260). The processor 258 may be a single core processor or a multiple core processor composed of a variety of materials, such as silicon, polysilicon, high-K dielectric, copper, and so on. The CRM 260 may include any suitable memory or storage device such as RAM, SRAM, DRAM, NVRAM, ROM, or Flash memory useable to store device data 262 of the base stations 120. The device data 262 includes network scheduling data, radio resource management data, beamforming codebooks, applications, and/or an operating system of the base stations 120, which are executable by processor(s) 258 to enable communication with the UEs 110 operating on one or more RANs 140 provided via the base station 120.

In aspects, the CRM 260 of the base station 120 also includes channel and beam management functions 264. Alternatively or additionally, the channel and beam management functions 264 may be implemented in whole or part as hardware logic or circuitry integrated with or separate from other components (e.g., wireless transceivers 256) of the base station 120. Generally, the channel and beam management functions 264 enable the base station to perform channel sounding procedures and determine communication configurations for downlink or uplink communications between the base station 120 and the UE 110. For example, the base station 120 may use the channel and beam management functions 264 to request a channel sounding procedure with the UE 110, estimate characteristics of wireless channels, generate channel state information, determine precoding matrices, select beamforming patterns or directions, and so forth. The uses and implementations of the channel and beam management functions 264 vary and are described throughout the disclosure.

The CRM 260 also includes a base station manager 266 to manage various functionalities of the base station 120. Alternatively or additionally, the base station manager 266 may be implemented in whole or part as hardware logic or circuitry integrated with or separate from other components of the base stations 120. In at least some aspects, the base station manager 266 configures the antennas 252, RF front end 254, or wireless transceivers 256 of the base station 120 for communication with the UE 110, as well as communication with a core network. The base stations 120 include an inter-base station interface 268, such as an Xn and/or X2 interface, which the base station manager 266 configures to exchange user-plane and control-plane data between another base station 120, to manage the communication of the base stations 120 with the UE 110. The base stations 120 include a core network interface 270 that the base station manager 266 configures to exchange user-plane and control-plane data with core network functions and/or entities.

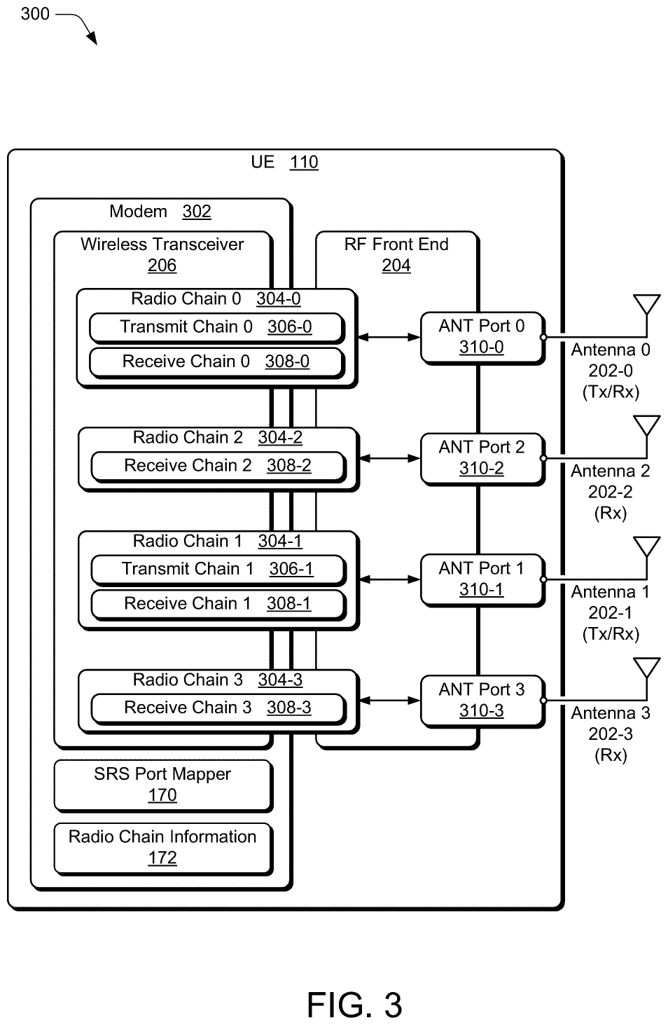

FIG. 3 illustrates at 300 an example configuration of components for implementing various aspects of adaptive sounding reference signal mapping for improved channel estimation. The illustrated components may be implemented in any suitable device, system, or apparatus, such as a user equipment, a user device, a mobile device, a mobile station, or the like. The components and architecture of the example configuration are presented as a non-limiting example of ways in which various entities for enabling adaptive sounding reference signal mapping for improved channel estimation can be implemented. As such, the aspects described herein may be applied or extended to any suitable combination or configuration of components and/or circuitry for implementing various features of adaptive sounding reference signal mapping for improved channel estimation.

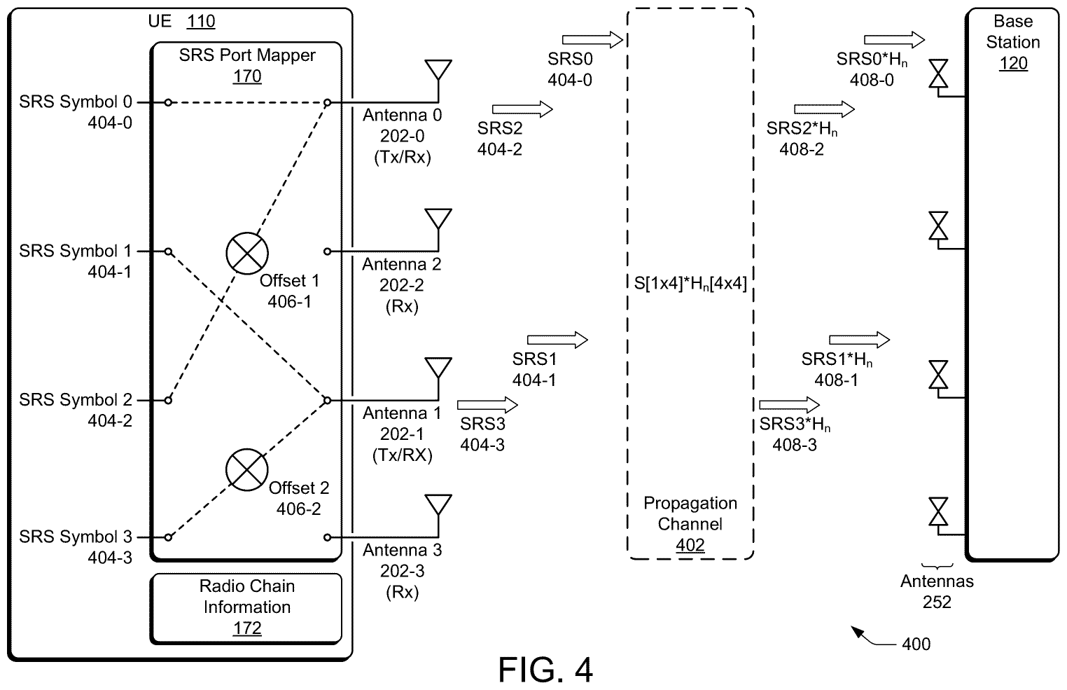

In this example, the components are illustrated in the context of a UE 110, which may be implemented as described with reference to FIG. 2 or otherwise throughout the disclosure. Generally, the UE 110 includes a modem 302 that provides a wireless communication interface by which the UE 110 communicates user-plane and/or control-plane information with base stations 120 of a wireless network. The modem 302 can be implemented as or part of a radio card, radio module, modem baseband processor, wireless communication processor, system-on-chip, LTE transceiver, 5G NR transceiver, or 6G transceiver, such as any of those described with reference to FIG. 1, FIG. 2, or FIGS. 4-15. To facilitate wireless communication, the modem 302 implements various data- and signal-processing functions, which may include encoding, decoding, modulation, demodulation, analog-to-digital conversion, digital-to-analog conversion, or the like. In some cases, the modem 302 is configured as a multi-mode multi-band modem through which a transceiver is embodied at least in part for wireless communication using multiple radio access technologies (RATs) (e.g., LTE, 5G NR, 6G) in multiple frequency bands.

Generally, the modem 302 includes transmitters and receivers, illustrated here in combination as an instance of a wireless transceiver 206, to communicate in one or more RATs and/or one or more frequency bands. As shown in FIG. 3, the respective transmit and receive functions of the wireless transceiver 206 include radio chains 304 (or communication paths) that are coupled between the wireless transceiver 206, RF front end 204, and/or the antennas 202 of the UE 110. A radio chain 304 or communication path of the wireless transceiver may be configured with transmit capabilities and/or receive capabilities. Thus, a radio chain 304 may include an instance of a transmit chain 306, an instance of a receive chain 308, or both transmit and receive chains to support transmit and receive capabilities.

The transmit chains 306, which may also be referred to as transmit paths, operably couple the transmitter of the modem 302 (e.g., transmit port) to the RF front end 204 and/or antennas 202 of the UE 110. In aspects, the transmit chains 306 include respective instances of transmitter components, functionality, and circuitry (not shown) that provide a chain or path by which the modem 302 transmits user and/or control information via a channel or carrier signal through a wireless medium. For example, an instance of a transmit chain 306 may include a set of transmitter components and circuitry that encode, modulate, up-convert, amplify, route, and transmit an individual or separate stream or channel of signaling and/or data. As such, a transmit chain 306 can include a transmitter module or section of the modem 302, digital-to-analog conversion circuitry, RF transceiver circuitry, RF switches and diplexers of the RF front end 204, an antenna port 310, and one of the antennas 202.

The receive chains 308, which may also be referred to as receive paths, operably couple the receiver of the modem 302 (e.g., receiver port) to the RF front end 204 and/or antennas 202 of the UE 110. In aspects, the receive chains 308 may each include respective instances of receiver components, functionality, and circuitry that provide a chain or path by which the modem 302 receives user and/or control information via a channel or carrier signal through a wireless medium. For example, an instance of a receive chain 308 may include a set of receiver components and circuitry that decode, demodulate, down-convert, amplify, filter, route, and receive an individual or separate stream or channel of signaling and/or data. As such, a receive chain 308 can include a receiver module or section of the modem 302, analog-to-digital conversion circuitry, RF transceiver circuitry, RF switches and diplexers of the RF front end 204, an antenna port 310, and one of the antennas 202.

In some aspects, the UE 110 includes one or two transmit-capable radio chain 304 or transmitter paths that can be switched to at least two of antennas 202 for transmit operations. In other words, the wireless transceiver 206 and RF front end 204 of the UE 110 may be configured to physically support 1T2R or 2T2R antenna switching configurations for channel sounding procedures or other transmissions. In this example, the UE 110 includes two transmit-capable radio chains (e.g., 2T2R), although aspects of adaptive sounding reference signal mapping may be implemented with one transmit radio chain (e.g., 1T2R). With reference to FIG. 3, a first radio chain 0 304-0 of the UE 110 is configured for both receive and transmit operations and includes components of a transmit chain 0 306-0 and a receive chain 308-0 that can be coupled to a first antenna port 310-0. A second radio chain 1 304-1 of the UE 110 is also configured for both receive and transmit operations and includes components of a transmit chain 2 306-1 and a receive chain 308-1 that can be coupled to a second antenna port 310-1 for transmit and/or receive operations.

Additionally, a third radio chain 2 304-2 of the UE 110 is configured for receive operations and includes components of a receive chain 1 308-2 that can be coupled to a third antenna port 310-2. A fourth radio chain 3 304-3 of the UE 110 is also configured for receive operations and includes components of a receive chain 3 308-3 that can be coupled to a fourth antenna port 310-3. Although not shown, components of the RF front end 204 may enable the coupling of each of the radio chains 304-0 through 304-3 to a respective antenna port 310-0 through 310-3 of the UE 110. Thus, in this example UE 110 configuration, two of the radio chains 304 are capable of transmitting signals and communications to the base station 120 and all four of the radio chains 304 are capable of receiving signaling and communications from the base station 120.

FIG. 4 illustrates at 400 an example antenna port mapping for transmitting sounding reference signal symbols in accordance with one or more aspects. As described herein, a UE may implement adaptive SRS symbol mapping to realize a 1T4R channel estimation with a 1T2R hardware configuration or realize a 2T4R channel estimation with a 2T2R hardware configuration, and so forth. To do so, the UE may leverage the fact that a mapping of SRS symbols or SRS transmission ports by the UE is not explicitly visible to a receiving base station of the network, instead these symbols or ports are seen by the base station as an integrated part of an overall communication channel. In aspects of adaptive sounding reference signal mapping, the UE transmits SRS symbols through a propagation channel 402 (Hₙ) of a wireless medium between the UE 110 and the base station 120.

By way of review, a channel model Hₙ between a base station (e.g., gNB or eNB) and a UE is composed of antenna matrices Fᵣₓ and Fₜₓ and per-cluster channel matrices hₙ as shown in equation 1 for the channel model.

Hₙ(t;τ)=§§ Fᵣₓ(hₙ)(t;τ,ϕ,φ)Fₜₓ^{T}(ϕ)dϕdφ Equation 1: Communication Channel Model

In the context of the communication channel between the base station and the UE, the base station antenna(s) Fₜₓ and UE antenna(s) Fᵣₓ are an integrated part of the channel, such that Fₜₓ and Fᵣₓ include both respective antenna elements (arrays) and radio chains of the UE and base station. The propagation paths between the UE and base station can be divided into two sections Hₙ=H_{n_p}*H_{n_t}, where the first section H_{n_p}, includes the over-the-air section Hₙ and Fₜₓ (gNB/eNB) and a second section H_{n_t} includes the UE's Fᵣₓ. Generally, the first section is which includes the over-the-air section of the channel, is larger than the second section H_{n_t} of the UE's radio chains and respective antennas.

In the context of a primary transmit antenna (e.g., 202-0 first antenna) and a receive-only antenna (e.g., 202-2 third antenna), H_{1_p} and H_{3_p} may represent respective over-the-air propagation path sections and H_{1_t} and H_{3_t} can represent the respective UE radio chains and corresponding antennas (e.g., radio chain 0 304-0 and antenna 202-0 (primary transmit chain), and radio chain 304-2 and antenna 202-2 (third receive chain)). With respect to channel differences between these communication paths, most of the signal traveling distance is the over-the-air section of the channel between the base station and the UE. Additionally, the antennas 252 of the base station typically have higher directivity (e.g., directional gain). As such, the H_{1_p} and H_{3_p} sections have a much larger impact on the channel's time, frequency, polarization and spatial selectivity, which are generally the four domains of the channel model.

From the perspective of the UE-centric section of the channel H_{1_t} and H_{3_t}, channel differences arise from variations in respective amplifier gain, noise figures, antenna patterns, or antenna gain of the UE's radio chains. As such, in relation to the over-the-air portion of the channel, the conducted portion of the channel that relates to respective characteristics of UE radio chains is smaller, enabling the described aspects to properly account for or compensate for the differences between the radio chains. For example, a UE 110 can be implemented with antenna(s) that are nearly omni-directional, with relatively small differences in pattern, and/or gain variation between the antennas. Thus, from the UE's perspective through a primary transmit antenna and a receive-only antenna (or other UE antenna pair), the observed channel to the base station (e.g., gNB) appears very similar regardless of whether the propagation paths are line-of-sight or heavy multipath. In other words, a delta between the H_{n_t} is a much smaller portion of the entire channel model Hₙ, which can be used to enable the described aspects, which can compensate or address the differences in UE radio chains when performing channel sounding procedures. Based on this channel analysis and by leveraging the fact that SRS symbol mappings are not explicitly visible to a receiving base station of the network, the SRS port mapper 170 of the UE 110 can manage the mapping of SRS symbols and settings of transmit chains to approximate channel sounding procedures for a receive-only antenna. By so doing, the described aspects of adaptive SRS mapping may improve channel estimation, yield higher throughput, and extended network coverage for the UE.

As shown in FIG. 4, the UE 110 sounds the propagation channel 402 by transmitting four SRS symbols 404-0 through 404-3 through the propagation channel to the antenna array 252 of the base station 120. For example, the base station 120 may request that a UE transmit a set of four SRS symbols for channel sounding, which is then used for determining a configuration (e.g., precoder matrix) for uplink transmissions or a configuration (e.g., beamforming pattern) for downlink transmissions. Although not shown, the four SRS symbols 404-0 through 404-3 may be transmitted via one transmit-capable radio chain (e.g., 1T2R hardware) as described or two transmit-capable radio chains (e.g., 2T2R hardware).

As part of a channel sounding procedure, the SRS port mapper 170 maps a first SRS symbol 0 404-0 (or its SRS port) and a third SRS symbol 2 404-2 (or its SRS port) to the antenna port of antenna 0 202-0. The SRS port mapper 170 also maps a second SRS symbol 1 404-1 (or its SRS port) and a fourth SRS symbol 3 404-3 (or its SRS port) to the antenna port of antenna 1 202-1. The UE 110 then transmits the first SRS symbol 404-0 via the first antenna 202-0 and transmits the second SRS symbol 404-1 via the second antenna. In aspects, the SRS port mapper 170 applies, based on the radio chain information 172, a first offset 406-1 to the transmit-capable radio chain to which the third SRS symbol 404-2 is mapped and applies a second offset 406-2 to the transmit-capable radio chain to which the fourth SRS symbol 404-3 is mapped. In some cases, application of the offsets includes adjusting path gains of the first and/or second radio chains of the UE 110. While the offsets are applied, the UE sends the third SRS symbol 404-2 and the fourth SRS symbol 404-3 via the respective antenna ports of the first antenna 202-0 and the second antenna 202-1. As shown in FIG. 4, the set of SRS symbols 404 passes through the propagation channel and the base station 120 receives the channel-affected SRS symbols 408-0 through 408-3 via the antennas 252 of the base station. Based on the received SRS symbols 408, which approximate channel sounding for the four UE antennas 202-0 through 202-3, the base station estimates characteristics of the propagation channel 402. In other words, the base station 120 may estimate the channel as though the UE 110 transmitted the set of SRS symbols in accordance with a 1T4R, 2T4R, or 4T=4R hardware configuration despite the UE 110 including a 1T2R or a 2T2R hardware configuration.

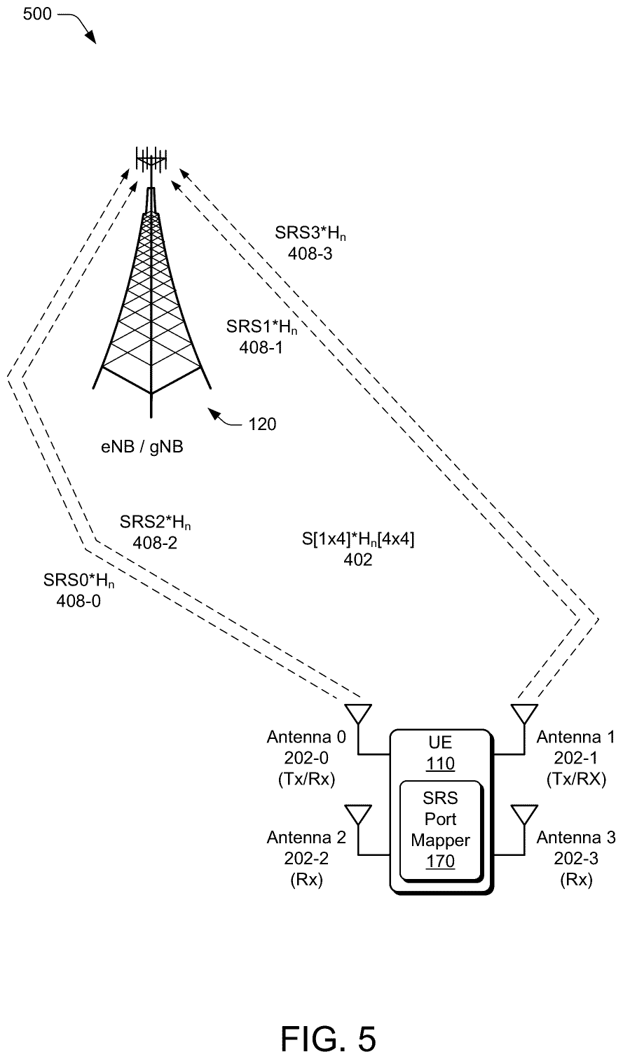

As another example, consider FIG. 5 which illustrates an example wireless network environment 500 in which a user equipment can transmit sounding reference signals to a base station in accordance with one or more aspects. Here, the SRS port mapper 170 enables the UE 110 to implement a procedure to sound the propagation channel 402 by transmitting the four SRS symbols 408 through the channel via the primary antenna 202-0 and secondary antenna 202-1 of the UE 110. As described herein, the UE 110 can send the third and fourth SRS symbols via the respective antenna ports of the first and second antennas (e.g., transmit capable radio paths) effective to approximate channel sounding for the third and fourth radio paths. By so doing, the UE can reduce the channel estimation errors due to the parametric delta between the primary/secondary and third/fourth radio paths. In some cases, the resulting channel estimates provided by the described aspects that approximate a 1T4R or 2T4R channel sounding are effective to increase downlink throughput to the UE by as much as 15% over a 1T2R channel sounding.

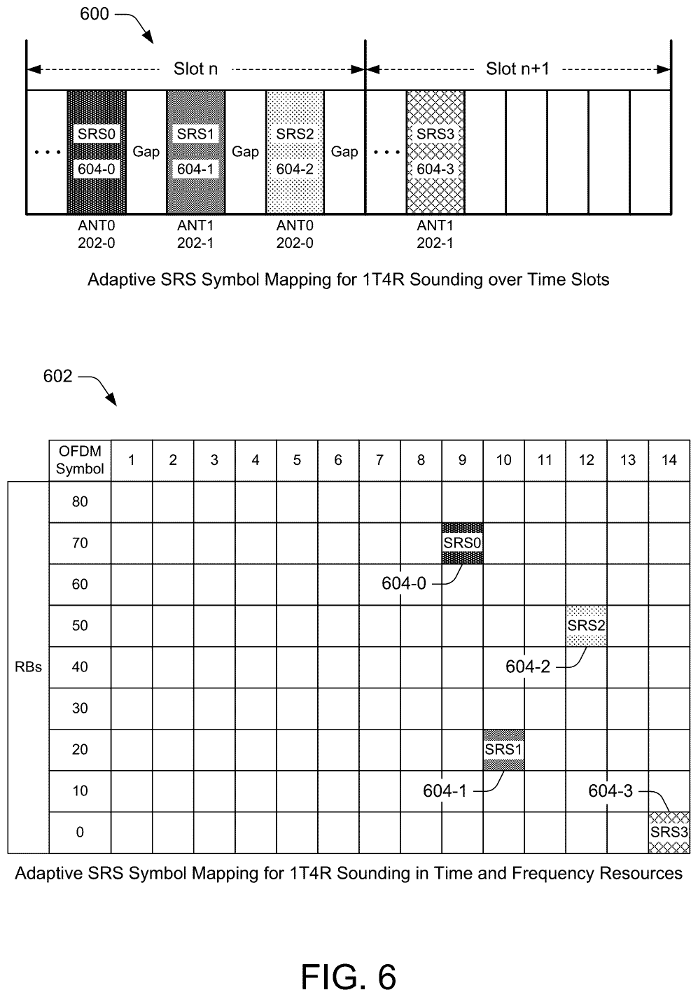

FIG. 6 illustrates an example time slot graph 600 and an example resource grid 602 of time and frequency resources in which sounding reference signal symbols can be mapped in accordance with one or more aspects. In this example, a UE 110 adaptively maps four SRS symbols 604-0 through 604-3 to physical antenna ports of a 1T2R hardware configuration to implement a 1T4R channel sounding. Here, the 1T2R hardware configuration may correspond to radio chain 0 304-0 and antenna 0 202-0 and antenna 1 202-1 of the UE 110, with the RF front end 204 supporting physical switching between the radio chain and antennas. With reference to the time slot graph 600 and in the context of the time domain, an SRS port mapper 170 of the UE maps a first SRS 0 symbol 604-0 to an antenna port of ANT 0 202-0 (e.g., primary TX antenna) for transmission during a first time slot (e.g., Slot n). The SRS port mapper 170 also maps a second SRS 1 symbol 604-1 to an antenna port of ANT 1 202-1 (e.g., secondary TX antenna) for transmission during the first time slot. A third SRS 2 symbol 604-2 is also mapped to the antenna port of ANT 0 202-0 for transmission during the first time slot and a fourth SRS 3 symbol 604-3 is mapped to the antenna port of ANT 1 202-1 for transmission during a following time slot (e.g., Slot n+1).

In the time domain and frequency domain, as shown in the resource grid 602, the SRS port mapper 170 maps the four SRS symbols 604-0 through 604-3 across OFDM symbols and resource blocks for physical transmission by the radio chain 0 304-0 of the UE. Generally, the implementation of 1T4R channel sounding includes sending the four SRS symbols through four SRS ports or four antenna ports, hut not necessarily four separate physical antenna ports, the different antenna ports logically share a same set of resource elements and a same basic SRS sequence, Because of this, the SR S port, mapper can apply four different phase rotations, which is equivalent to applying cyclic shift in the time domain, to separate the four SRS symbols 604-0 through 604-3 for transmission by one or two radio chains and their corresponding antennas. In other words, the SRS port mapper 170 can apply four different phase rotations to one SRS Resource Set to provide the four different SRS symbols 604-0 through 604-3 that correspond to an SRS symbol sequence for a 1T4R channel sounding.

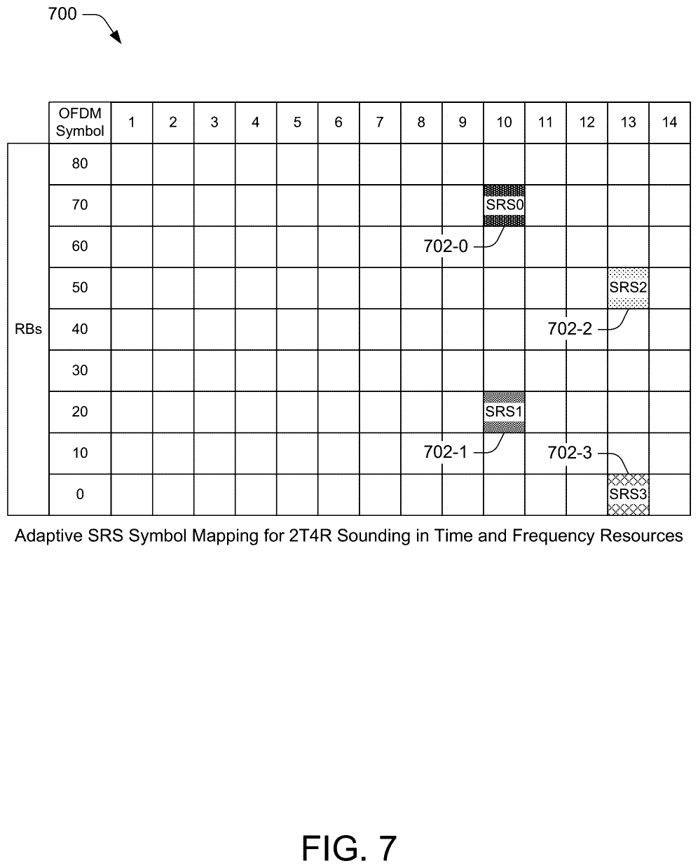

As another example, consider FIG. 7, which illustrates another example resource grid 700 in which sounding reference signal symbols are mapped in accordance with one or more aspects. In this example, a UE 110 adaptively maps four SRS symbols 702-0 through 702-3 to physical antenna ports of a 2T2R hardware configuration to implement a 2T4R channel sounding. Here, the 2T2R hardware configuration may correspond to radio chain 0 304-0, radio chain 1 304-1, antenna 0 202-0, and antenna 1 202-1 of the UE 110. Generally, the SRS port mapper 170 can apply aspects similar to those described with reference to 1T2R hardware configurations (e.g., FIG. 6) in a UE with the 2T2R hardware configurations to enable 2T4R channel sounding. In other words, the SRS port mapper can apply a similar mapping as described with reference to the adaptive mapping for the 1T4R channel sounding to implement a 2T4R channel sounding with a 2T2R hardware configuration of the UE 110. With reference to the time and frequency resources of the resource grid 702, the SRS port mapper 170 of the UE maps a first SRS 0 symbol 702-0 to an antenna port of ANT 0 202-0 (e.g., primary TX antenna) for transmission by a first radio chain 304-0. The SRS port mapper 170 also maps a second SRS 1 symbol 702-1 to an antenna port of ANT 1 202-1 (e.g., secondary TX antenna) for transmission by a second radio chain 304-1. A third SRS 2 symbol 702-2 is also mapped to the antenna port of ANT 0 202-0 for transmission by the first radio chain 304-0 and a fourth SRS 3 symbol 702-3 is mapped to the antenna port of ANT 1 202-1 for transmission by the second radio chain 304-1. By so doing, each of the two antennas of the LE 110 transmits simultaneously a general complex value weighted combination of two SRS symbols per time slot. The adaptive SRS symbol mappings described with reference to FIGS. 6 and 7 may also be implemented in the SRS port mapper in relation to the following aspects of adaptive sounding reference signal mapping.

### Example Transactions of Adaptive Sounding Reference Signal Mapping

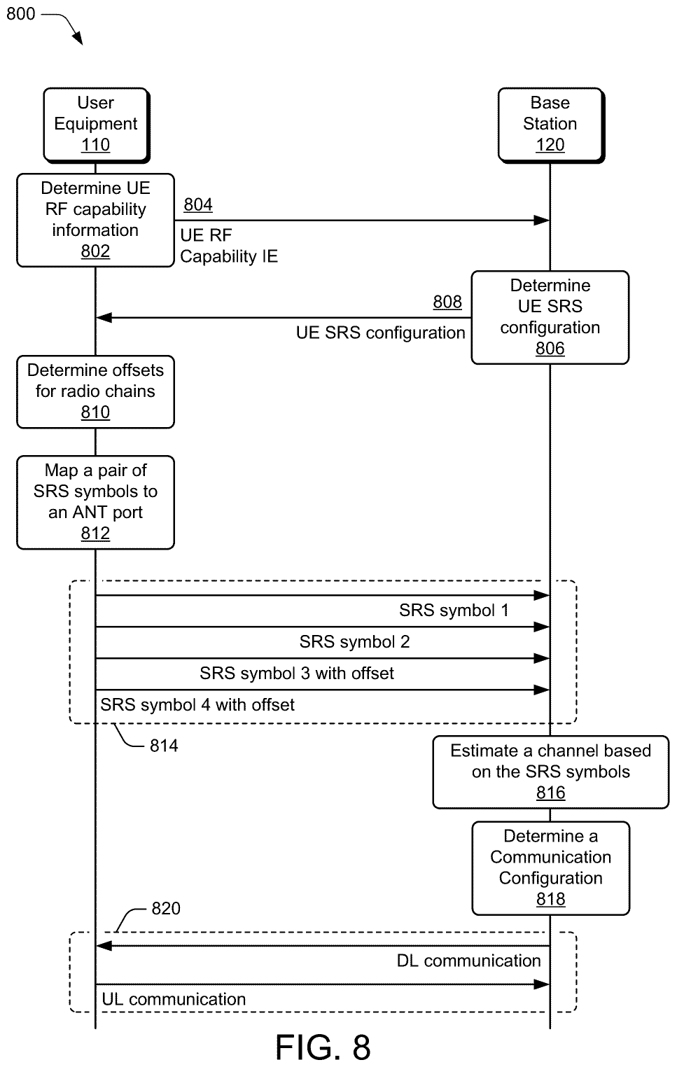

FIG. 8 illustrates an example signaling and control transaction diagram 800 that includes a combination of actions, signaling transactions, and/or control transactions that can be used to perform aspects of adaptive sounding reference signal mapping, such as transmitting multiple SRS symbols that include a modified or offset SRS symbol via one antenna of a UE. In some aspects, the actions or transactions described with reference to the diagram 800 can be used with the entities or diagrams as described with reference to FIGS. 1-6 or FIGS. 8-14.

At 802, a UE (e.g., UE 110) determines UE RF capability information associated with a channel sounding procedure. An SRS port mapper of the UE may determine UE capability information that is different than a capability supported by a hardware configuration of the UE. In some cases, the SRS port mapper generates or modifies UE RF capability information to indicate that the UE supports transmission by at least three antennas (e.g., four receive antennas) when hardware of the UE is configured to support transmission by two or fewer antennas. For example, the SRS port mapper can generate or edit a “supportedSRS-TxPortSwitch” to indicate support for a 1T4R, a 2T4R, or a 4T=4R antenna switching hardware configuration. At 804, the UE transmits a UE RF capability information element to a base station (e.g., base station 120). The UE RF capability information may be transmitted as part of a UE capability message sent to the base station. Alternatively or additionally, the UE may transmit an indication that the UE is capable of transmitting via more antennas than supported by the hardware configuration of the UE.

At 806, the base station determines a UE SRS configuration for the UE. Based on the capabilities indicated by the UE, the base station can request one or more antenna switch configurations for a channel sounding procedure. The base station may also determine an SRS resource set for the UE to use for a channel sounding procedure. For example, the base station may request that the UE transmit SRS symbols in accordance with a 1T4R, a 2T4R, or a 4T=4R antenna switching hardware configuration. At 808, the base station transmits the UE SRS configuration to the UE. In some cases, the base station transmits a radio resource control (RRC) parameter effective to cause the UE to configure and use SRS antenna switching (e.g., SRS-ResourceSet.usage=antennaSwitching) as part of the channel sounding procedure. Alternatively or additionally, the UE SRS configuration may be sent by the base station as part of a channel sounding request.

At 810, the UE determines offsets for two or more radio chains of the UE based on a difference between the radio chains (e.g., communication paths including a respective antenna). The SRS port mapper of the UE may access radio chain information of the UE to generate or determine respective offsets for pairs of radio chains. In some cases, the SRS port mapper determines an offset for a transmit-capable radio chain based on a difference between the transmit-capable radio chain and a receive-only radio chain.

At 812, the UE maps a pair of a set of SRS symbols to an antenna port of the UE. In the context of the SRS configuration requested by the base station, a first of the pair of SRS symbols may correspond to the transmit-capable radio chain and a second of the pair of SRS symbols may correspond to the receive-only radio chain. In some cases, the SRS port mapper maps one pair of SRS symbols to an antenna port of a first transmit chain and one pair of SRS symbols to an antenna port of a second transmit chain (e.g., for a 2T2R configured UE). In other cases, the SRS port mapper maps two pairs of SRS symbols to an antenna port of a transmit chain of the UE (e.g., for a 1T2R configured UE).

At 814, the UE transmits the set of SRS symbols to the base station via the mapped antenna ports. In this example, the UE transmits first and second SRS symbols (e.g., respective first SRS symbols to two pairs of SRS symbols) via respective first and second transmit-capable radio chains of the UE. The SRS port mapper of the UE then applies the offsets to the first and second transmit-capable radio chains of the UE. With the offsets applied, the UE transmits third and fourth SRS symbols (e.g., respective second SRS symbols to two pairs of SRS symbols) via respective first and second transmit-capable radio chains of the UE. By so doing, the UE may use a 2T2R hardware configuration to approximate a transmission of SRS symbols in accordance with a four-antenna channel sounding configuration, such as a 1T4R, a 2T4R, or a 4T=4R configuration.

In other cases, the UE transmits a first SRS symbol via a first transmit-capable radio chain of the UE (e.g., a transmit chain switched to a first antenna). The UE also transmits a second SRS symbol via a second transmit-capable radio chain of the UE (e.g., a transmit chain switched to a first antenna). The SRS port mapper of the UE then applies a first offset to the first transmit-capable radio chain and transmits, with the first offset applied, a third SRS symbol via the first transmit-capable radio chain. Next, the SRS port mapper applies a second offset to the second transmit-capable radio chain and transmits, with the second offset applied, a fourth SRS symbol via the second transmit-capable radio chain. By so doing, the UE may use a 1T2R hardware configuration to approximate a transmission of SRS symbols in accordance with a four-antenna channel sounding configuration, such as a 1T4R, a 2T4R, or a 4T=4R configuration.

At 816, the base station estimates a channel between the UE and the base station based on the set of SRS symbols received from the UE. Because the set of SRS symbols transmitted in accordance with aspects of adaptive sounding reference signal mapping approximate additional channels, the base station can estimate the channel with more accuracy than when fewer SRS symbols or UE transmit chains are used. At 818, the base station determines a communication configuration based on the estimate of the channel. The base station may determine a configuration for a transmitter of the base station (e.g., beamforming pattern or direction) and/or a configuration for the transmitter of the UE (e.g., precoder configuration). Generally, using the improved-accuracy channel estimate enables the base station to determine respective transmitter configurations that better match the communicate channel between the UE and the base station, which can increase throughput of downlink or uplink communications.

At 820, the UE and base station communicate based on the communication configuration by the base station. In some cases, the base station uses a downlink communication configuration determined from the adaptively mapped SRS symbols to transmit downlink signals or information to the UE. Alternatively or additionally, the UE uses an uplink communication configuration determined from the adaptively mapped SRS symbols to transmit uplink signals or information to the base station. As described herein, the use of adaptive SRS symbol mapping may improve channel estimation, which in turn enables the determination of better communication configurations and/or increased throughput when communicating through the channel.

### Example Methods

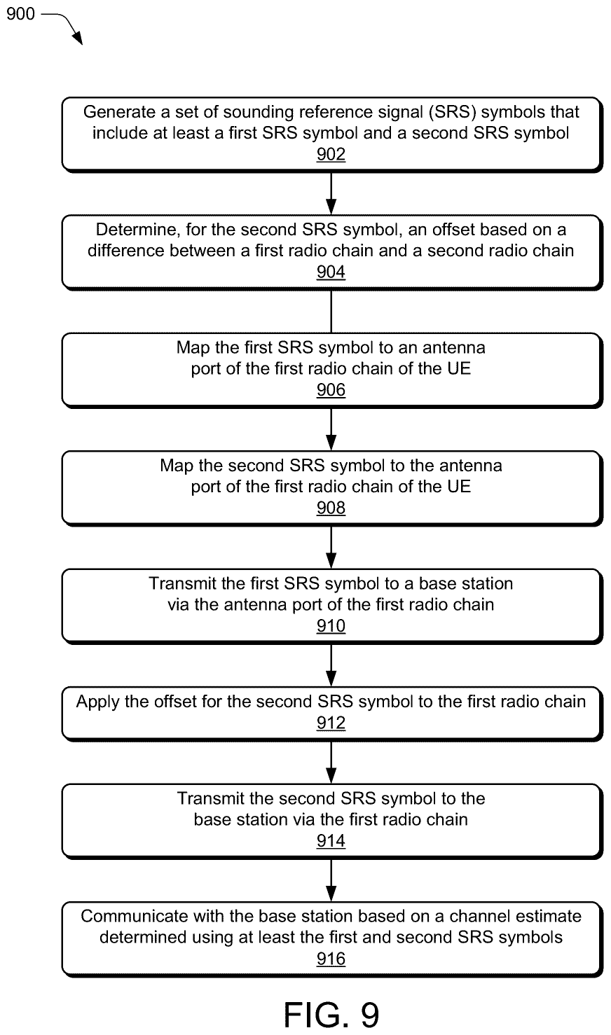

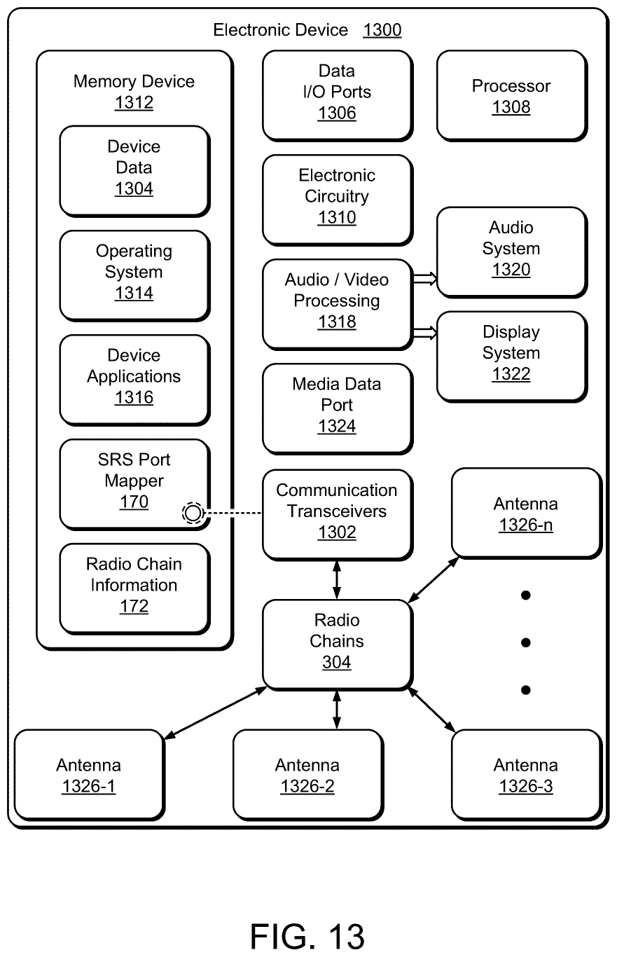

Example methods 900 through 1100 are described with reference to FIGS. 9-11B, respectively, in accordance with one or more aspects of adaptive sounding reference signal mapping for improved channel estimation. Alternately or additionally, various aspects of radio chain characterization and assignment that enable adaptive sounding reference signal mapping are described with reference to one or more methods. Generally, the methods 900 through 1100 illustrate sets of operations (or acts) that may be performed in, but not necessarily limited to, the order or combinations in which the operations are shown herein. Further, any of one or more of the operations may be repeated, combined, reorganized, skipped, or linked to provide a wide array of additional and/or alternate methods. In portions of the following discussion, reference may be made to the environment 100 of FIG. 1, devices, components, implementations, or configurations of FIG. 2 through FIG. 8, devices or systems of FIG. 13 through FIG. 15, and/or entities detailed in FIG. 1 or other figures, reference to which is made for example only. The techniques and apparatuses described in this disclosure are not limited to being embodied in or performance by one entity or multiple entities operating on one device or those described with reference to the figures.

FIG. 9 illustrates an example method 900 for adaptive sounding reference signal mapping in accordance with one or more aspects, including operations performed by an SRS port mapper (e.g., SRS port mapper 170 of FIG. 1). In some aspects, operations of the method 900 may be implemented by a user equipment to transmit a sequence of SRS symbols that enable improved channel estimation by a base station.

At 902, a UE (e.g., UE 110) generates a set of SRS symbols that include at least a first SRS symbol and a second SRS symbol. The UE may generate a set of four SRS symbols or sequences that correspond to respective antennas in accordance with a four-antenna channel sounding configuration, such as a 1T4R, a 2T4R, or a 4T=4R configuration.

At 904, the UE determines, for the second SRS symbol, an offset based on a difference between the first radio chain and a second radio chain of the UE. An SRS port mapper of the UE may determine the offset based on respective measurements or calibration information of the first radio chain and the second radio chain. In some cases, the first radio chain is a transmit-capable radio chain, and the second radio chain is a receive-only radio chain. Alternatively or additionally, the SRS port mapper may determine another offset based on a difference between a third radio chain and a fourth radio chain of the UE. Determining an offset may include determining an adjustment to the path gain (or other transmission parameter) of the first radio chain such that, when the path gain of the first radio chain is adjusted, the first radio chain approximates the second radio chain.

At 906, the UE maps the first SRS symbol to an antenna port of the first radio chain of the UE. The SRS port mapper may map a first SRS symbol that corresponds to the transmit-capable radio chain to a physical antenna port of the transmit-capable radio chain. At 908, the UE maps the second SRS symbol to the antenna port of the first radio chain of the UE. The SRS port mapper may map a second SRS symbol that corresponds to the receive-only radio chain to the physical antenna port of the transmit-capable radio chain. In other words, the second SRS symbol can be mapped to the physical antenna of the transmit-capable radio chain and be scheduled for time and frequency resources of an air interface that are intended for use by another radio chain.

At 910, the UE transmits the first SRS symbol via the antenna port of the first radio chain of the UE. The UE may transmit the first SRS symbol via first time and frequency resources that correlate to a first antenna of a four-antenna channel sounding procedure. At 912, the UE applies the offset for the second SRS symbol to the first radio chain. By so doing, the UE may compensate or adapt the first radio chain to approximate another radio chain of the UE, such as a receive-only transmit chain. Applying the offset may include adjusting the path gain of the first radio chain. At 914, the UE transmits the second SRS symbol via the antenna port of the first radio chain while the offset is applied to the first radio chain. The UE may transmit the second SRS symbol via second time and frequency resources that correlate to a second antenna of a four-antenna channel sounding procedure. In aspects, the UE may repeat one or more of operations 904 through 914 to transmit, via a second transmit-capable radio chain (e.g., a 2T2R configured UE), third and fourth SRS symbols that correspond to a third radio chain and a fourth radio chain (e.g., receive-only) of the UE. In other aspects, the UE may repeat one or more of operations 904 through 914 to transmit, via the transmit-capable radio chain (e.g., a 1T2R configured UE), third and fourth SRS symbols that correspond to a third and fourth radio chains (e.g., receive-only) of the UE.

At 916, the UE communicates with the base station based on channel state information determined using at least the first and second SRS symbols. As described, the base station may determine more-accurate channel state information based on the adaptively mapped SRS symbols that approximate additional communication channels. This channel state information may then be used to determine communication configurations for the UE or base station that enable higher-throughput communication through the channel between the UE and base station.

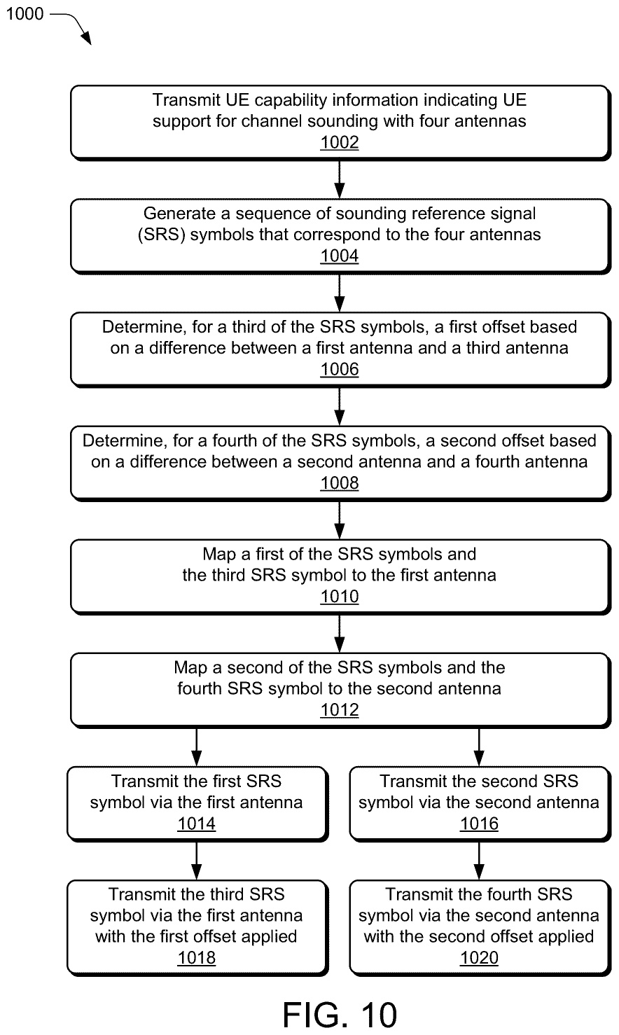

FIG. 10 illustrates an example method 1000 for mapping offset sounding reference signal symbols to respective antennas in accordance with one or more aspects, including operations performed by an SRS port mapper (e.g., SRS port mapper 170 of FIG. 1). In some aspects, operations of the method 1000 are performed by a user equipment (e.g., a 2T2R) to transmit a sequence of four SRS symbols to a base station via respective antennas of two transmit chains.

At 1002, a UE (e.g., UE 110) transmits UE capability information to a base station (e.g., base station 120) that indicates UE support for channel sounding with four antennas. For example, the UE may transmit a UE capability information element that indicates that the UE is capable of 2T4R antenna switching.

At 1004, the UE generates a sequence of sounding reference signal (SRS) symbols that correspond to four antennas of the UE. The UE may generate the sequence of SRS signals in accordance with a four-antenna channel sounding procedure. In some cases, the SRS symbols are assigned to SRS transmission ports that correspond to the 2T4R antenna switching configuration.

At 1006, the UE determines, for a third one of the SRS symbols, a first offset based on a difference between the first antenna and the third antenna of the UE. At 1008, the UE determines, for a fourth one of the SRS symbols, a second offset based on a difference between the second antenna and the fourth antenna of the UE. The UE may determine the first and second offsets based on respective measurement information (e.g., radio chain information) for radio chains of the first antenna and third antenna, or the second antenna and fourth antenna. In some cases, the first and second antennas are primary and secondary transmit antennas of the UE and the third and fourth antennas are receive-only antennas (e.g., MIMO receiving antennas) of the UE.

At 1010, the UE maps a first of the SRS symbols and the third SRS symbol to the first antenna. An SRS port mapper of the UE may map the third symbol or an SRS transmission port of the third symbol to the antenna port of the first antenna. At 1012, the UE maps a second of the SRS symbols and the fourth SRS symbol to the second antenna. The SRS port mapper of the UE may map the fourth symbol or an SRS transmission port of the fourth symbol to the antenna port of the second antenna. In other words, the SRS port mapper can map the sequence of SRS symbols or the SRS transmission ports of the sequence to the first and second antenna ports of the UE.

At 1014, the UE transmits, to a base station and through a channel, the first SRS symbol via the first radio chain of the first antenna. At 1016, the UE transmits, to the base station and through the channel, the second SRS symbol via the second radio chain of the second antenna. The transmission of the first and second SRS symbols enable the base station to estimate channel characteristics for first and second communication paths through the channel.

At 1018, the UE transmits, to the base station and through the channel, the third SRS symbol via the first antenna with the first offset applied to the first radio chain. At 1020, the UE transmits, to the base station and through the channel, the fourth SRS symbol via the second antenna with the second offset applied to the second radio chain. By applying the respective offsets to the first and second radio chains, the SRS port mapper can approximate transmission of the third and fourth SRS symbols by the third and fourth radio chains (e.g., receive-only radio chains). Thus, the transmission of the third and fourth SRS symbols enables the base station to estimate channel characteristics for the third and fourth communication paths through the channel. Accordingly, aspects of adaptive sounding reference signal mapping may enable the base station to more-accurately estimate channel characteristics based on the four communication paths through the channel (2T4R) instead of only two communication paths as enabled by the hardware configuration (1T2R) of the UE with preceding techniques.

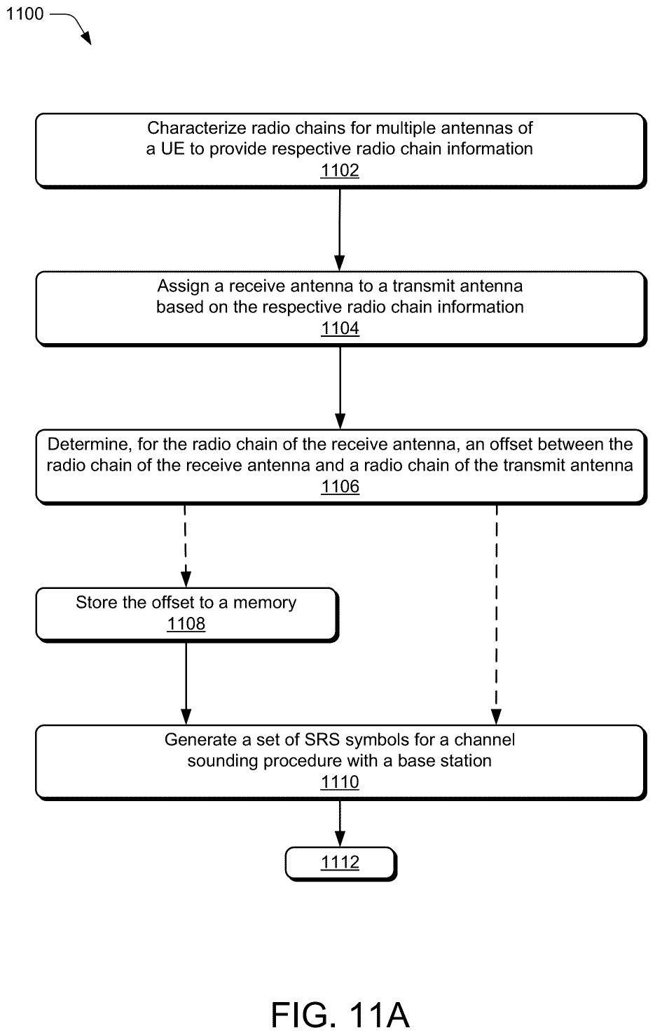

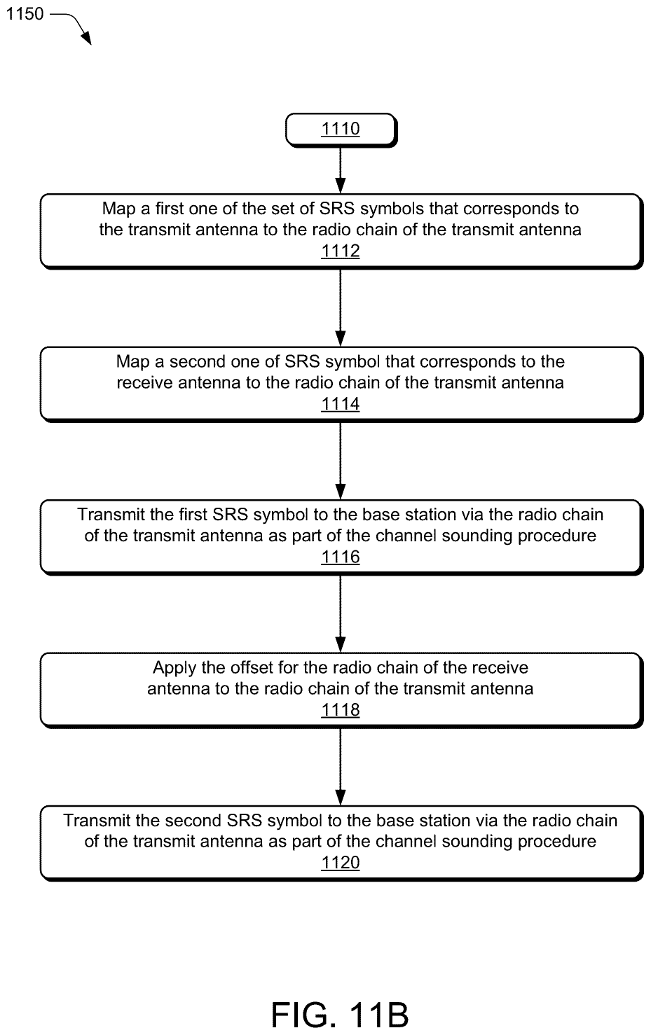

FIGS. 11A and 11B illustrate an example method 1100 for enabling a user equipment to perform aspects of adaptive sounding reference signal mapping, including operations performed by an SRS port mapper (e.g., SRS port mapper 170 of FIG. 1). In some aspects, operations of the method 1100 are performed by a user equipment to characterize and pair respective antennas of radio chains for adaptive sounding reference signal mapping.

At 1102, a UE (e.g., UE 110) characterizes radio chains for multiple antennas of the UE to provide respective radio chain information. For example, a total isotropic sensitivity (TIS) can be performed for multiple antennas and corresponding radio chains of the UE and the measurement results stored in a memory of the UE or a modem of the UE. The UE may also determine calibration information or receive metrics for the multiple antennas and corresponding radio chains to store as radio chain information.

At 1104, the UE assigns a receive antenna to a transmit antenna based on the respective radio chain information. Given that channel estimation may rely on the reciprocity of downlink and uplink communications (e.g., in TDD networks), if performance characteristic differences between radio chains of antennas are excessive, there may be no benefit of adaptive SRS symbol mapping to approximate additional receive-only radio chains. For example, when a receive-only radio chain (e.g., third or fourth radio chain) has 5 dB or more lower gain relative a transmit-capable radio chain (e.g., primary or secondary radio chain) for a particular frequency band, then channel estimates with 1T4R, (or 2T4R) may perform worse than those tier 1T2R (or 2T2R). As such, aspects of adaptive SRS symbol mapping may characterize and pair multiple radio chains of the UE for optimized SRS symbol mapping to corresponding SRS transmit or physical antenna ports.

In the context of operation 1104, the Ur may compare respective radio chain information for the multiple radio chains of the TIE to determine differences in performance characteristics between pairs of the radio chains (e.g., a transmit-capable radio chain and a receive-only radio chain). In some cases, the TIE compares a difference in performance characteristics (e.g., relative gain or receive sensitivity) to a threshold (e.g., 5 dB) to determine whether adaptive SRS mapping should be implemented. In response to the difference in performance exceeding the threshold, the UE determines to not implement adaptive SRS mapping for the pair of radio chains. In response to the difference in performance not exceeding the threshold, the UE determines to implement adaptive SRS mapping for the pair of radio chains. In some aspects, the UE may compare different pairs of the radio chains (e.g., pairs of a transmit-capable radio chain and a receive-only radio chain) to determine performance differences for the multiple pairs. The UE may then assign (or pair) a receive antenna radio chain to a transmit antenna radio chain with the least difference in performance. In other words, the UE may assign or pair together the radio chains that most closely match in performance.

At 1106, the UE determines, for the radio chain of the receive antenna, an offset between a radio chain of the receive antenna and a radio chain of the transmit antenna. Based on an assignment or pairing of radio chains, the UE can determine an offset between the radio chain of the receive antenna and the radio chain of the transmit antenna. In some cases, the UE determines the offset by accessing radio chain information that indicates respective receive performance or calibration metrics of the radio chains. The UE may also use the information relating to the difference in performance between radio chains as determined in operation 1104. Optionally at 1108, the UE stores the offset for the pair of radio chains of the receive antenna to a memory of the UE or a memory of a modem with which the radio chains are coupled.

At 1110, the UE generates a set of SRS symbols for a channel sounding procedure. The UE may generate the set of SRS symbols for channel sounding in accordance with a 1T4R, a 2T4R, or a 4T=4R antenna switching configuration. From operation 1110, the method 1100 proceeds from FIG. 11A to operation 1112 of FIG. 11B as shown at 1150.

At 1112, the UE maps a first of the set of SRS symbols that corresponds to the transmit antenna to the radio chain of the transmit antenna. The UE may map the first SRS symbol that corresponds to the transmit antenna to the transmit-capable radio chain or a physical antenna port of the transmit-capable radio chain. At 1114, the UE maps a second of the set of SRS symbols that corresponds to the receive antenna to the radio chain of the transmit antenna. The UE may map a second SRS symbol that corresponds to the receive antenna to the transmit-capable radio chain or the physical antenna port of the transmit-capable radio chain. In other words, the second SRS symbol can be mapped to the physical antenna of the transmit-capable radio chain and be scheduled for time and frequency resources of an air interface that are intended for use by another radio chain in the 1T4R, the 2T2R, or 4T=4R antenna switching configuration.

At 1116, the UE transmits the first SRS symbol to the base station via the radio chain of the transmit antenna as part of the channel sounding procedure. The UE may transmit the first SRS symbol via first time and frequency resources that correlate to a first antenna of a four-antenna channel sounding procedure. At 1118, the UE applies the offset for the receive chain of the receive antenna to the radio chain of the transmit antenna. By so doing, the UE may compensate or adapt the transmit-capable radio chain to approximate another radio chain of the UE, such as the receive-only transmit chain of the receive antenna.

At 1120, the UE transmits the second SRS symbol to the base station via the radio chain of the transmit antenna as part of the channel sounding procedure. The second SRS symbol is transmitted using the radio chain of the transmit antenna while the offset is applied to the radio chain. The UE may transmit the second SRS symbol via second time and frequency resources that correlate to a second antenna of a four-antenna channel sounding procedure. In aspects, the UE may repeat one or more of operations 1112 through 1120 to transmit, via a second transmit-capable radio chain (e.g., a 2T2R configured UE), third and fourth SRS symbols that correspond to a third radio chain and a fourth radio chain (e.g., receive-only) of the UE. In other aspects, the UE may repeat one or more of operations 1112 through 1120 to transmit, via the transmit-capable radio chain (e.g., a 1T2R configured UE), third and fourth SRS symbols that correspond to a third and fourth radio chains (e.g., receive-only) of the UE to approximate a 1T4R sounding procedure.

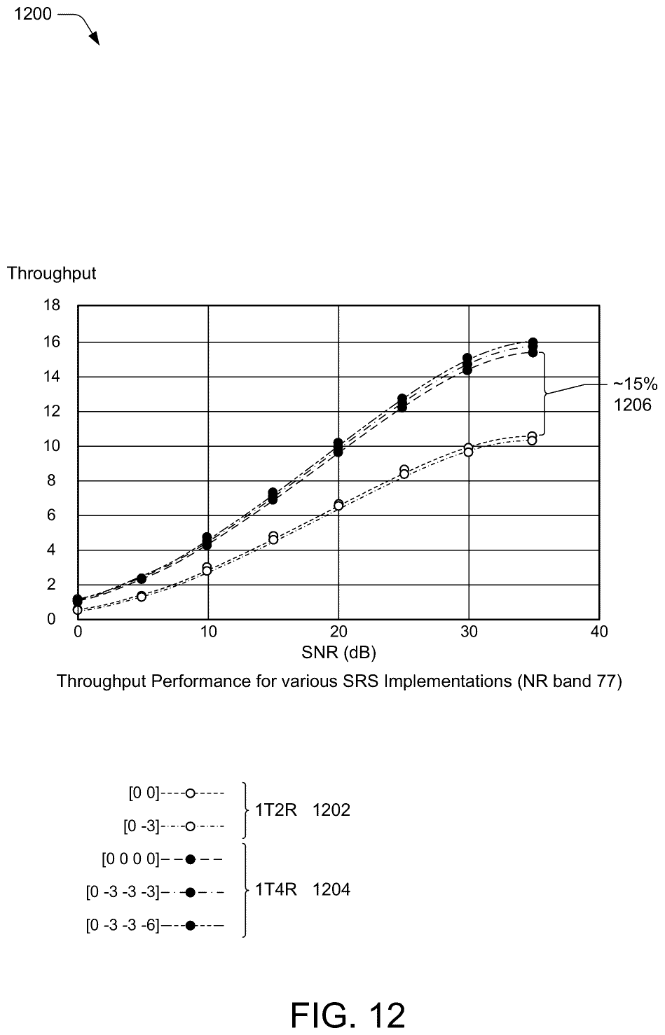

As described, the base station may determine more-accurate channel state information based on the adaptively mapped SRS symbols that approximate additional communication channels. This channel state information may then be used to determine communication configurations for the UE or base station that enable higher-throughput communication through the channel between the UE and base station. By way of example, consider FIG. 12 in which an example graph 1200 illustrates improved throughput performance of a user equipment provided by adaptive sounding reference signal mapping in accordance with the described aspects. Generally, a sounding channel is used by the UE to send SRS symbols for downlink channel estimation, rank selection, and beamforming management. By implementing aspects of adaptive sounding reference signal mapping, the UE can improve the downlink throughput, as well as network coverage. As shown in FIG. 12, for typical 1T2R hardware configurations 1202, a UE can implement aspects of adaptive sounding reference signal mapping to approximate 1T4R antenna configurations 1204 to achieve 15 percent (15% at 1206) higher downlink throughput in NR band 77. Here, note that with radio chain performance that varies by as much as 6 dB (e.g., 1T4R (0 −3 −3 −6)), the UE may still improve achieve increased throughput over a hardware-limited (e.g., 1T2R (0 −3)) configuration.

### Example Devices and Systems

FIGS. 13-15 illustrate examples of a device, system-on-chip, and wireless communication processor that can implement various aspects of adaptive sounding reference signal mapping for improved channel estimation. These entities, either alone or in combination, may implement one or more aspects of adaptive sounding reference signal mapping described with reference to the preceding FIGS. 1-12. The device, system-on-chip, or wireless communication processor may be implemented with any suitable combination of components or elements and may include other components shown or described with reference to any of the other FIGS. 1-12.

FIG. 13 illustrates various components of an example electronic device 1300 that can implement adaptive sounding reference signal mapping in accordance with one or more aspects described herein. The electronic device 1300 may be implemented as any one or a combination of a fixed or mobile device, in any form of a consumer device, computing device, portable device, user device, user equipment, server, communication device, phone, navigation device, gaming device, media device, messaging device, media player, and/or other type of electronic device or a wirelessly-enabled device. For example, the electronic device 1300 may be implemented as a smart-phone, phone-tablet (phablet), laptop computer, set-top box, wireless drone, computing-glasses, wearable-computer, vehicle-based computing system, or wireless broadband router.

The electronic device 1300 includes communication transceivers 1302 that enable wired and/or wireless communication of device data 1304, such as transmitting data, receiving data, or other information as described herein. Example communication transceivers 1302 include NFC transceivers, WPAN radios compliant with various IEEE 802.15 standards, WLAN radios compliant with any of the various IEEE 802.11 standards, WWAN (3GPP-compliant) radios, LTE transceivers, 5G NR transceivers, 6G transceivers, wireless metropolitan area network (WMAN) radios compliant with various IEEE 802.16 standards, and wired local area network (LAN) Ethernet transceivers. In some aspects, multiple communication transceivers 1302 or components thereof are operably coupled with respective instances of radio chains 304 embodied on the electronic device 1300. The radio chains 304 may be implemented similar to the radio chain 0 304-0 through radio chain 3 304-3 (e.g., transceiver chains or receive-only chains) as described with reference to FIGS. 1-12. In this example, the radio chains 30x may include at least four radio chains that an SRS port mapper 170 may use to implement various aspects of adaptive sounding reference signal mapping to improve channel estimation.

The electronic device 1300 may also include one or more data input/output ports 1306 (data I/O ports 1306) via which any type of data, media content, and/or other inputs can be received, such as user-selectable inputs, messages, applications, music, television content, recorded video content, and any other type of audio, video, and/or image data received from any content and/or data source. The data I/O ports 1306 may include USB ports, coaxial cable ports, and other serial or parallel connectors (including internal connectors) for flash memory, DVDs, CDs, and the like. These data I/O ports 1306 may be used to couple the electronic device to components, peripherals, or accessories such as keyboards, microphones, or cameras.

The electronic device 1300 of this example includes at least one processor 1308 (e.g., one or more application processors, processor cores microprocessors, digital signal processors (DSPs), controllers, or the like), which can include a combined processor and memory system, that executes computer-executable instructions stored on computer-readable media to control operations or implement functionalities of the device. Generally, a processor or processing system may be implemented at least partially in hardware, which can include components of an integrated circuit or on-chip system, a DSP, an application-specific integrated circuit (ASIC), a field-programmable gate array (FPGA), a complex programmable logic device (CPLD), and other implementations in silicon and/or other hardware.

Alternatively or additionally, the electronic device 1300 can be implemented with any one or combination of electronic circuitry 1310, which may include hardware, fixed logic circuitry, or physical interconnects (e.g., traces or connectors) that are implemented in connection with processing and control circuits. This electronic circuitry 1310 can implement executable or hardware-based modules (not shown) through logic circuitry and/or hardware, such as an FPGA or CPLD. Although not shown, the electronic device 1300 may also include a system bus, interconnect fabric, crossbar, or data transfer system that couples the various components within the device. A system bus or interconnect fabric can include any one or combination of different bus structures or IP blocks, such as a memory bus, memory controller, a peripheral bus, a universal serial bus, interconnect nodes, and/or a processor or local bus that utilizes any of a variety of bus architectures.

The electronic device 1300 also includes one or more memory devices 1312 that enable data storage, examples of which include RAM, SRAM, DRAM, NVRAM, ROM, flash memory, EPROM, EEPROM, and a disk storage device. Any or all of the memory devices 1312 may enable persistent and/or non-transitory storage of information, data, or code, and thus do not include transitory signals or carrier waves in the general context of this disclosure. For example, the memory device(s) 1312 provide data storage mechanisms to store the device data 1304 and other types of data (e.g., user data). The memory device 1312 may also store an operating system 1314, firmware, and/or device applications 1316 of the electronic device as instructions, code, or information. These instructions or code can be executed by the processor 1308 to implement various functionalities of the electronic device, such as to provide a user interface, enable data access, or manage connectivity with a wireless network.

In this example, the memory device 1312 also stores processor-executable code or instructions for providing an instance of an SRS port mapper 170, which may be implemented similar to or differently from the SRS port mapper described with reference to FIGS. 1-12. The memory device also includes an instance radio chain information 172 with which the SRS port mapper 170 may interact to implement aspects of adaptive sounding reference signal mapping as described herein. For example, the SRS port mapper 170 may characterize respective receive metrics of multiple radio chains, store the respective receive metrics as part of the radio chain information 172, and determine radio chain offsets based on the radio chain information 172. As part of a channel sounding procedure, the SRS port mapper 170 can map multiple SRS symbols to one physical antenna port and apply, during transmission of at least one of the multiple SRS symbols, an offset to a transmit chain to implement aspects of adaptive sounding reference signal mapping for improved channel estimation. The SRS port mapper 170 of the electronic device 1300 may implement these and any other aspects of adaptive sounding reference signal mapping as described herein.

As shown in FIG. 13, the electronic device 1300 may include an audio and/or video processing system 1318 for processing audio data and/or passing through the audio and video data to an audio system 1320 and/or to a display system 1322 (e.g., a video buffer or device screen). The audio system 1320 and/or the display system 1322 may include any devices that process, display, and/or otherwise render audio, video, graphical, and/or image data. Display data and audio signals can be communicated to an audio component and/or to a display component via an RF link, S-video link, HDMI (high-definition multimedia interface), Display Port, composite video link, component video link, DVI (digital video interface), analog audio connection, or other similar communication link, such as a media data port 1324. In some implementations, the audio system 1320 and/or the display system 1322 are external or separate components of the electronic device 1300. Alternately, the display system 1322 can be an integrated component of the example electronic device 1300, such as part of an integrated display with a touch interface.

The electronic device 1300 also includes antennas 1326-1, 1326-2, through 1326-n, where n may be any suitable number of antennas. The antennas 1326-1 through 1326-n are coupled, via an RF front end (not shown), to radio chains 30x of the electronic device 1300, which may include any suitable combination of components to facilitate transmission or reception of signals by the communication transceivers 1302 through of the antennas 1326-1 through 1326-n. In some aspects, each of the antennas 1326-1 through 1326-n correspond to a respective radio chain 304 or antenna port 310 (not shown) of the electronic device. Generally, the SRS port mapper 170 may interact with any of the radio chain information 172, communication transceivers 1302, radio chains 304, antenna ports 310, and/or antennas 1326-1 through 1326-n to implement adaptive sounding reference signal mapping for improved channel estimation as described herein. Alternatively or additionally, the electronic device 1300 may represent an example implementation of the user equipment 110 as described throughout the present disclosure. Thus, in some cases the processor 1308 is an example of the processor 208 (not shown) and/or the memory device 1312 is an example of the computer-readable storage media 210 (not shown) for storing various data, instructions, or code for implementing an SRS port mapper, radio chain information, or other applications. As such, aspects of adaptive sounding reference signal mapping for improved channel estimation as described herein can be implemented by, or in conjunction with, the electronic device 1300 of FIG. 13.

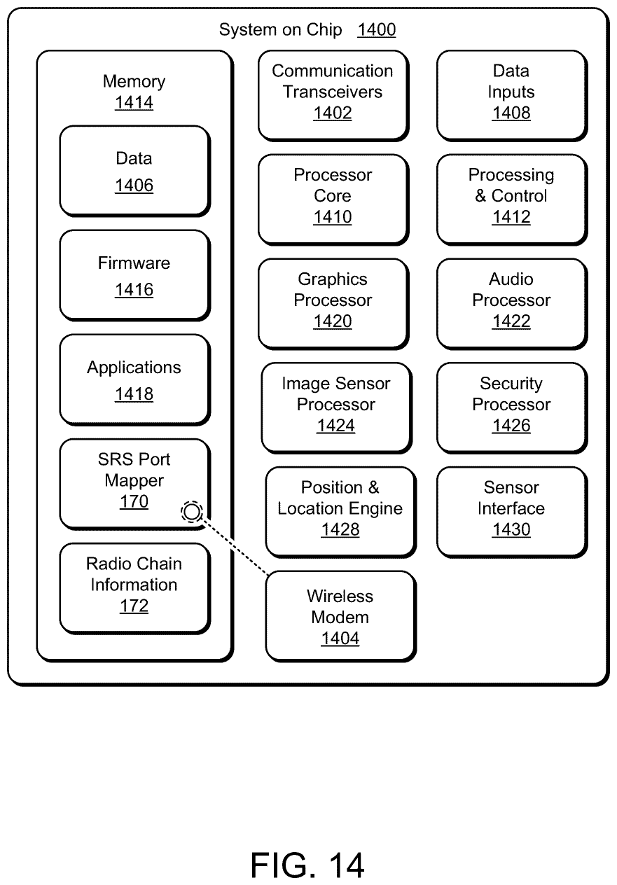

FIG. 14 illustrates an example system-on-chip (SoC) that may implement aspects of adaptive sounding reference signal mapping for improved channel estimation. The SoC 1400 may be embodied as or within any type of user equipment 110, user equipment, apparatus, other device, or system as described with reference to FIGS. 1-13 or FIG. 15 to implement adaptive sounding reference signal mapping for improved channel estimation. Although described with reference to chip-based packaging, the components shown in FIG. 14 may also be embodied as other systems or component configurations, such as, and without limitation, a Field-Programmable Gate Arrays (FPGA), an Application-Specific Integrated Circuits (ASIC), an Application-Specific Standard Products (ASSP), a digital signal processor (DSP), Complex Programmable Logic Devices (CPLD), system in package (SiP), package on package (PoP), processing and communication chip set, communication co-processor, sensor co-processor, or the like.

In this example, the SoC 1400 includes communication transceivers 1402 and a wireless modem 1404 that enable wired or wireless communication of system data 1406 (e.g., received data, data that is being received, data scheduled for transmission, packetized, or the like). In some aspects, the wireless modem 1404 is a multi-mode multi-band modem or baseband processor that is configurable to communicate in accordance with various communication protocols and/or in different frequency bands, such as those protocols (e.g., LTE, 5G NR, or 6G) or frequency bands described throughout this disclosure. The wireless modem 1404 may include a transceiver interface (not shown) for communicating encoded or modulated signals with transceiver circuitry, including transmitter chain and receiver chain circuitry (e.g., radio chain 0 304-0 through radio chain 3 304-3 of a UE 110). The wireless modem 1404 may also include or be associated with an instance of an SRS port mapper 170 and radio chain information 172, which are shown in FIG. 14.

The system data 1406 or other system content can include configuration settings of the system or various components, media content stored by the system, and/or information associated with a user of the system. Media content stored on the system on chip 1400 may include any type of audio, video, and/or image data. The system on chip 1400 also includes one or more data inputs 1408 via which any type of data, media content, and/or inputs can be received, such as user input, user-selectable inputs (explicit or implicit), or any other type of audio, video, and/or image data received from a content and/or data source. Alternatively or additionally, the data inputs 1408 may include various data interfaces, which can be implemented as any one or more of a serial and/or parallel interface, a wireless interface, a network interface, and as any other type of communication interface enabling communication with other devices or systems.

The system on chip 1400 includes one or more processor cores 1410, which process various computer-executable instructions to control the operation of the system on chip 1400 and to enable techniques for adaptive sounding reference signal mapping for improved channel estimation. Alternatively or additionally, the system on chip 1400 can be implemented with any one or a combination of hardware, firmware, or fixed logic circuitry that is implemented in connection with processing and control circuits, which are generally shown at 1412. Although not shown, the system on chip 1400 may also include a bus, interconnect, crossbar, or fabric that couples the various components within the system.

The system on chip 1400 also includes a memory 1414 (e.g., computer-readable media), such as one or more memory circuits that enable persistent and/or non-transitory data storage, and thus do not include transitory signals or carrier waves. Examples of the memory 1414 include RAM, SRAM, DRAM, NVRAM, ROM, EPROM, EEPROM, or flash memory. The memory 1414 provides data storage for the system data 1406, as well as for firmware 1416, applications 1418, and any other types of information and/or data related to operational aspects of the system on chip 1400. For example, the firmware 1416 can be maintained as processor-executable instructions of an operating system (e.g., real-time OS) within the memory 1414 and executed on one or more of the processor cores 1410.

The applications 1418 may include a system manager, such as any form of a control application, software application, signal processing and control module, code that is native to a particular system, an abstraction module or gesture module and so on. The memory 1414 may also store system components or utilities for implementing aspects of adaptive sounding reference signal mapping for improved channel estimation, such as an SRS port mapper 170 and radio chain information 172. These entities may be embodied as combined or separate components, examples of which are described with reference to corresponding entities or functionality as illustrated in FIGS. 1-13 or FIG. 15. In some aspects, the SRS port mapper 170 interacts with the radio chain information 172 and the wireless modem 1404 to implement aspects of adaptive sounding reference signal mapping. For example, the SRS port mapper 170 may map multiple SRS symbols to a same physical antenna port and apply an offset to a transmit chain of the antenna port when transmitting at least some of the SRS symbols to approximate channel sounding through other antennas of an apparatus or device. By so doing, the SRS port mapper 170 may enable improved channel estimation and increased throughput of downlink or uplink communications. Although shown in memory 1414, one or more elements of the SRS port mapper 170 may be implemented, in whole or in part, through hardware or firmware.

In some aspects, the system-on-chip 1400 also includes additional processors or co-processors to enable other functionalities, such as a graphics processor 1420, audio processor 1422, and image sensor processor 1424. The graphics processor 1420 may render graphical content associated with a user interface, operating system, or applications of the system-on-chip 1400. In some cases, the audio processor 1422 encodes or decodes audio data and signals, such as audio signals and information associated with voice calls or encoded audio data for playback. The image sensor processor 1424 may be coupled to an image sensor and provide image data processing, video capture, and other visual media conditioning and processing functions.

The system-on-chip 1400 may also include a security processor 1426 to support various security, encryption, and cryptographic operations, such as to provide secure communication protocols and encrypted data storage. Although not shown, the security processor 1426 may include one or more cryptographic engines, cipher libraries, hashing modules, or random number generators to support encryption and cryptographic processing of information or communications of the system-on-chip 1400. Alternatively or additionally, the system-on-chip 1400 can include a position and location engine 1428 and a sensor interface 1430. Generally, the position and location engine 1428 may provide positioning or location data by processing signals of a Global Navigation Satellite System (GNSS) and/or other motion or inertia sensor data (e.g., dead-reckoning navigation). The sensor interface 1430 enables the system-on-chip 1400 to receive data from various sensors, such as capacitance and motion sensors. In some aspects, the SRS port mapper 170 may interact with any of the processor or co-processor of the system-on-chip 1400 to enable adaptive sounding reference signal mapping for improved channel estimation.

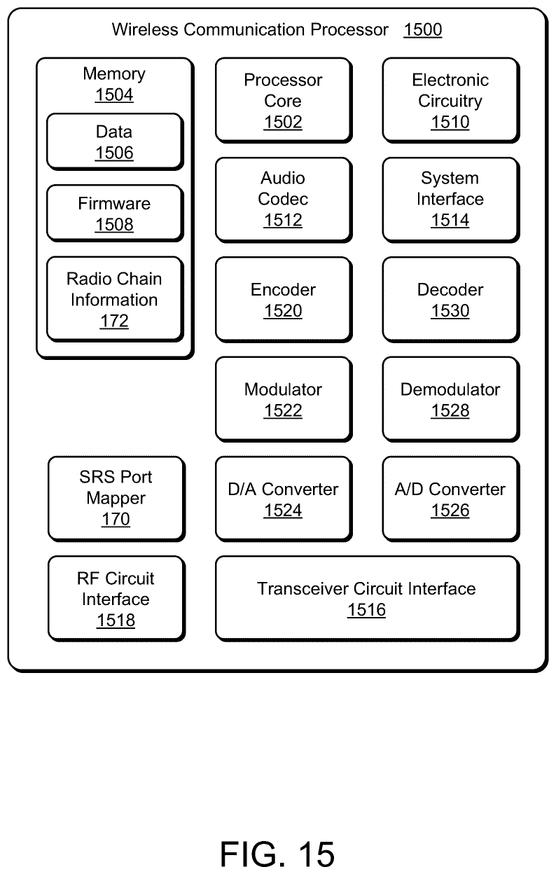

FIG. 15 illustrates an example configuration of a wireless communication processor 1500 (communication processor 1500) that may implement various aspects of adaptive sounding reference signal mapping for improved channel estimation. Although referred to generally as a communication processor, the communication processor 1500 may be implemented as a modem baseband processor, software defined radio module, configurable modem (e.g., multi-mode, multi-band modem), wireless data interface, or wireless modem, such as the wireless modem 1404 of the system-on-chip 1400. The wireless communication processor 1500 may be implemented in a device or system to support data access, messaging, or data-based services of a wireless network, as well as various audio-based communication (e.g., voice calls).

In this example, the wireless communication processor 1500 includes at least one processor core 1502 and a memory 1504, which is implemented as hardware-based memory that enables persistent and/or non-transitory data storage, and thus does not include transitory signals or carrier waves. The processor core 1502 may be configured as any suitable type of processor core, microcontroller, digital signal processor core, or the like. The memory 1504 may include any suitable type of memory device or circuit, such as RAM, DRAM, SRAM, NVRAM, ROM, flash memory, or the like. Generally, the memory stores data 1506 of the communication processor 1500, as well as firmware 1508 and other applications. The processor core 1502 may execute processor-executable instructions of the firmware 1508 or applications to implement functions of the communication processor 1500, such as signal processing and data encoding operations. The memory 1504 may also store data and information useful to implement aspects of adaptive sounding reference signal mapping for improved channel estimation. In some aspects, the memory 1504 of the communication processor 1500 includes radio chain information 172, modem and transceiver configuration information, or other information (not shown) useful to implement adaptive sounding reference signal mapping.

The communication processor 1500 may also include electronic circuitry 1510 for managing or coordinating operations of various components and an audio codec 1512 for processing audio signals and related data. The electronic circuitry 1510 may include hardware, fixed logic circuitry, or physical interconnects (e.g., traces or connectors) that are implemented in connection with processing and control circuits of the communication processor and various components. The audio codec 1512 may include a combination of logic, circuitry, or firmware (e.g., algorithms) to support encoding and/or decoding of audio information and audio signals, such as analog signals and digital data associated with voice or sound functions of the communication processor 1500.

A system interface 1514 of the communication processor 1500 enables communication with a host system or application processor. For example, the communication processor 1500 may provide or expose data access functionalities to the system or application processor through the system interface 1514. In this example, the communication processor also includes a transceiver circuit interface 1516 and an RF circuit interface 1518, through which the communication processor 1500 may manage or control respective functionalities of a transceiver circuit (e.g., transmit and receive chain circuitry) or RF front end to implement various communication protocols and techniques. In various aspects, the communication processor includes digital signal processing or signal processing blocks for encoding and modulating data for transmission or demodulating and decoding received data.

In this example, the communication processor 1500 includes an encoder 1520, modulator 1522, and digital-to-analog converter 1524 (D/A converter 1524) for encoding, modulating, and converting data sent to the transceiver circuit interface. The communication processor also includes an analog-to-digital converter 1526 (A/D converter 1526), a demodulator 1528, and a decoder 1530 for converting, demodulating, and decoding data received from the transceiver circuit interface 1516. In some aspects, these signal processing blocks and components are implemented as part of respective transmit and receive paths (e.g., radio chains 304-0 through 304-3) of the communication processor 1500, which may be configurable for different radio access technologies or frequency bands.

The wireless communication processor 1500 also includes an SRS port mapper 170, which may be embodied separately or combined with other components, examples of which are described with reference to corresponding entities or functionality as illustrated in FIGS. 1-14. In aspects, the SRS port mapper 170 interacts with the radio chain information 172 and other components of the wireless communication processor 1500 to implement adaptive sounding reference signal mapping for improved channel estimation. For example, the SRS port mapper 170 may characterize respective receive metrics of multiple radio chains, store the respective receive metrics as part of the radio chain information 172, and determine radio chain offsets based on the radio chain information 172. As part of a channel sounding procedure, the SRS port mapper 170 can map multiple SRS symbols to one physical antenna port and apply, during transmission of at least one of the multiple SRS symbols, an offset to a transmit chain in accordance with one or more aspects of adaptive sounding reference signal mapping for improved channel estimation. Based on the improved channel estimates, the wireless communication processor 1500 may communicate uplink or downlink data with increased throughput. Alternatively or additionally, the SRS port mapper 170 may cause or direct the wireless communication processor 1500 to implement any of the aspects of adaptive sounding reference signal mapping as described with reference to FIGS. 1-14.

Further to the descriptions above, a user may be provided with controls allowing the user to make an election as to both if and when devices, systems, applications, and/or features described herein may enable collection of user information, such as one or more of wireless link metrics (radio link metrics), connection duration information, average connection length, signal quality/strength information, network identity information, network basic service set identifier (B S SID) information, mobile network subscriber information, recently utilized wireless communication bands/channels, a user's preferences, a user's current location, if the user has communicated content or information with a server, or the like.

In addition, certain data may be treated in one or more ways before it is stored or used, so that personally identifiable information is removed. For example, a user's identity may be treated so that no personally identifiable information can be determined for the user. For example, a user's geographic location may be generalized or randomized about where location information is obtained (such as to a city, postal code, or state/province level), so that a particular location of a user cannot be determined. Thus, the user may have control(s) over what information is collected about the user, one or more devices of the user, how that information is used, and/or what information is provided to the user.

### Variations

Although the above-described apparatuses and techniques are described in the context of adaptive sounding reference signal mapping for improved channel estimation in a wireless network in which a user equipment may access one or more base stations, the described user equipment, devices, systems, and methods are non-limiting and may apply to other contexts, user equipment deployments, or wireless communication environments.

Generally, the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively, or in addition, any of the functionality described herein can be performed, at least in part, by one or more hardware logic components, such as, and without limitation, FPGAs, ASICs, ASSPs, SoCs, CPLDs, co-processors, context hubs, sensor co-processors, or the like.

A first method performed by a user equipment (UE) to implement adaptive sounding reference signal mapping comprises generating a set of sounding reference signal (SRS) symbols that include at least a first SRS symbol and a second SRS symbol; determining, for the second SRS symbol, an offset based on a difference between a first radio chain of the UE and a second radio chain of the UE; mapping the first SRS symbol to an antenna port of the first radio chain; mapping the second SRS symbol to the antenna port of the first radio chain; transmitting, to a base station, the first SRS symbol via the antenna port of the first radio chain; applying the offset for the second SRS symbol to the first radio chain; transmitting, to the base station, the second SRS symbol via the antenna port of the first radio chain with the offset applied to the first radio chain; and communicating with the base station based on channel state information determined using at least the first SRS symbol and the second SRS symbol.

In addition to the above described first method, a second method performed by a user equipment to implement adaptive sounding reference signal mapping comprises generating a sequence of sounding reference signal (SRS) symbols that correspond to four respective antennas of the multiple radio chains, the four respective antennas including at least a first antenna, a second antenna, a third antenna and a fourth antenna; determining, for a third one of the SRS symbols, a first offset based on a difference between a first radio chain of the first antenna and a third radio chain of the third antenna; determining, for a fourth one of the SRS symbols, a second offset based on a difference between a second radio chain of the second antenna and a fourth radio chain of the fourth antenna; mapping a first one of the SRS symbols and the third SRS symbol to the first radio chain of the first antenna; mapping a second one of the SRS symbols and the fourth SRS symbol to the second radio chain of the second antenna; transmitting, to a base station, the first SRS symbol via the first antenna of the first radio chain; transmitting, to the base station, the second SRS symbol via the second antenna of the second radio chain; applying the first offset to the first radio chain of the first antenna; applying the second offset to the second radio chain of the second antenna; transmitting, to the base station, the third SRS symbol via the first antenna of the first radio chain while the first offset is applied to the first radio chain; and transmitting, to the base station, the fourth SRS symbol via the second antenna of the second radio chain while the second offset is applied.

In addition to the above-described methods, a third method performed by a user equipment to enable the user equipment to perform adaptive sounding reference signal mapping comprises characterizing radio chains for multiple antennas of the user equipment (UE) to provide respective radio chain information; assigning an antenna of a receive-only radio chain to an antenna of a transmit capable radio chain based on the respective radio chain information; determining an offset between the receive-only radio chain and the transmit capable radio chain based on the respective radio chain information; and storing the offset information to a memory of the UE to enable mapping of sounding reference signal symbols from the antenna of the receive-only radio chain to the antenna of the transmit capable radio chain.

In addition to any of the methods described above, the antenna port is a first antenna port to a first antenna of the UE and the method further comprises transmitting, to the base station, an indication that the UE is capable of implementing a channel sounding procedure that includes transmitting the first SRS symbol via the first antenna; and transmitting the second SRS symbol via a second antenna of the UE that is coupled to a second antenna port of the second radio chain.

In addition to any of the methods described above or below, receiving, from the base station, a request to implement the channel sounding procedure by transmitting the first SRS symbol via the first antenna of the UE; and transmitting the second SRS symbol via the second antenna of the UE.

In addition to any of the methods described above or below, the request to implement the channel sounding procedure requests that the UE perform the channel sounding procedure by using use one of one transmit chain to four receive chain (1T4R) antenna switching; two transmit chain to four receive chain (2T4R) antenna switching; and a hardware configuration of the UE is not capable of implementing a 1T4R or 2T4R channel sounding procedure.

In addition to any of the methods described above or below, the first radio chain is configured for transmitting uplink communications and receiving downlink communications; and the second radio chain is configured for receiving downlink communications.

In addition to any of the methods described above or below, wherein the second radio chain is configured for only receiving downlink communications and is not capable of transmitting uplink communications.

In addition to any of the methods described above or below, the set of SRS symbols further comprises a third SRS symbol and a fourth SRS symbol, the offset is a first offset, the antenna port of the first radio chain is a first antenna port, and the method further comprises determining, for the fourth SRS symbol, a second offset based on a difference between a third radio chain of the UE and a fourth radio chain of the UE; mapping the third SRS symbol to a second antenna port of the third radio chain of the UE; mapping the fourth SRS symbol to the second antenna port of the third radio chain; transmitting, to the base station, the third SRS symbol via the second antenna port of the third radio chain; applying the second offset for the fourth SRS symbol to the third radio chain; transmitting, to the base station, the fourth SRS symbol via the second antenna port of the third radio chain with the second offset applied; and communicating with the base station based on channel state information determined using at least the first SRS symbol, the second SRS symbol, the third SRS symbol, and the fourth SRS symbol.

In addition to any of the methods described above or below, the mapping of the second SRS symbol to the antenna port of the first radio chain comprises mapping the second SRS symbol to a physical antenna port associated with the first radio chain.

In addition to any of the methods described above or below, the mapping of the second SRS symbol to the first radio chain comprises mapping the second SRS symbol to time resources or frequency resources of a resource grid for an air interface that are associated with an antenna or an antenna port of the second radio chain; or mapping the second SRS symbol from a first SRS port or a second SRS port to the antenna port of the first radio chain.

In addition to any of the methods described above or below, the offset is based on a difference in receive performance between the first radio chain and the second radio chain of the UE or the offset is determined as a transmitter gain adjustment for the first radio chain such that performance of the first radio chain approximates performance of the second radio chain.

In addition to any of the methods described above or below, determining the offset further comprises determining the offset by measuring a first receive performance metric of the first radio chain of the UE; measuring a second receive performance metric of the second radio chain of the UE; and determining a difference between the first receive performance metric and the second receive performance metric.

In addition to any of the methods described above or below, receiving, from the base station, an uplink configuration determined by the base station from the channel state information, and wherein the communicating further comprises transmitting an uplink communication to the base station in accordance with the uplink configuration.

In addition to any of the methods described above or below, the communicating further comprises receiving, from the base station, a downlink communication transmitted by the base station based on a downlink configuration determined by the base station from the channel state information.

A user equipment comprising at least one wireless transceiver; at least two radio chains coupled to respective antennas; a processor; and computer-readable storage media comprising instructions, responsive to execution by the processor, for directing the user equipment to perform any of the methods described above.

A system-on-chip comprising a transceiver module that includes a transmitter module and a receiver module; an interface to at least a first radio chain capable of transmit and receive operations; an interface to at least a second radio chain capable of receive operations; a memory storing radio chain offset information; a processor core configured to execute processor-executable instructions; and a computer-readable storage media comprising instructions that, responsive to execution by the processor core, direct a device in which the system-on-chip is embodied to perform any of the methods described above.

A computer-readable storage media comprising instructions that, responsive to execution by a processor, cause any of the methods described above to be performed.

Although various aspects of adaptive sounding reference signal mapping for improved channel estimation have been described in language specific to certain features, components, and/or methods, the subject matter of the appended claims is not necessarily limited to the specific features or methods described. Rather, the specific features and methods are disclosed as example implementations of managing modem and radio chain configurations and other equivalent features or methods are intended to be within the scope of the appended claims. Further, various different aspects are described, and it is to be appreciated that each described aspect can be implemented independently or in connection with other described aspects.

1. A method for sounding reference signal mapping performed by a user equipment (UE) to improve channel estimation, the method comprising:
generating a set of sounding reference signal (SRS) symbols that include at least a first SRS symbol and a second SRS symbol;
determining, for the second SRS symbol, an offset based on a difference between a first radio chain of the UE and a second radio chain of the UE;
mapping the first SRS symbol to an antenna port of the first radio chain;
mapping the second SRS symbol to the antenna port of the first radio chain;
transmitting, to a base station, the first SRS symbol via the antenna port of the first radio chain;
applying the offset for the second SRS symbol to the first radio chain;
transmitting, to the base station, the second SRS symbol via the antenna port of the first radio chain with the offset applied to the first radio chain; and
communicating with the base station based on channel state information determined using at least the first SRS symbol and the second SRS symbol.

2. The method as recited by claim 1, wherein the antenna port is a first antenna port to a first antenna of the UE and the method further comprises:
transmitting, to the base station, an indication that the UE is capable of implementing a channel sounding procedure that includes:
transmitting the first SRS symbol via the first antenna; and
transmitting the second SRS symbol via a second antenna of the UE that is coupled to a second antenna port of the second radio chain.

3. The method as recited by claim 2, further comprising:
receiving, from the base station, a request to implement the channel sounding procedure by:
transmitting the first SRS symbol via the first antenna of the UE; and
transmitting the second SRS symbol via the second antenna of the UE.

4. The method as recited by claim 3, wherein a hardware configuration of the UE is not capable of implementing a one transmit chain to four receive chain (1T4R) or a two transmit chain to four receive chain (2T4R) channel sounding procedure, and the request to implement the channel sounding procedure requests that the UE perform the channel sounding procedure by using one of:
1T4R antenna switching; or
2T4R antenna switching.

5. The method as recited by claim 1, wherein:
the first radio chain is configured for transmitting uplink communications and receiving downlink communications; and
the second radio chain is configured for receiving downlink communications.

6. (canceled)

7. The method as recited by claim 1, wherein:
the set of SRS symbols further comprises a third SRS symbol and a fourth SRS symbol, the offset is a first offset, the antenna port of the first radio chain is a first antenna port, and the method further comprises:
determining, for the fourth SRS symbol, a second offset based on a difference between a third radio chain of the UE and a fourth radio chain of the UE;
mapping the third SRS symbol to a second antenna port of the third radio chain of the UE;
mapping the fourth SRS symbol to the second antenna port of the third radio chain;
transmitting, to the base station, the third SRS symbol via the second antenna port of the third radio chain;
applying the second offset for the fourth SRS symbol to the third radio chain;
transmitting, to the base station, the fourth SRS symbol via the second antenna port of the third radio chain with the second offset applied; and
communicating with the base station based on channel state information determined using at least the first SRS symbol, the second SRS symbol, the third SRS symbol, and the fourth SRS symbol.

8. The method as recited by claim 1, wherein the mapping of the second SRS symbol to the antenna port of the first radio chain comprises mapping the second SRS symbol to a physical antenna port associated with the first radio chain.

9. The method as recited by claim 1, wherein the mapping of the second SRS symbol to the antenna port of the first radio chain comprises:
mapping the second SRS symbol to time resources or frequency resources of a resource grid for an air interface that are associated with an antenna or an antenna port of the second radio chain; or
mapping the second SRS symbol from a first SRS port or a second SRS port to the antenna port of the first radio chain.

10. The method as recited by claim 1, wherein:
the offset is determined based on a difference in receive performance between the first radio chain and the second radio chain of the UE; or
the offset is determined as a transmitter gain adjustment for the first radio chain such that performance of the first radio chain approximates performance of the second radio chain.

11. The method as recited by claim 1, wherein determining the offset further comprises determining the offset by:
measuring a first receive performance metric of the first radio chain of the UE;
measuring a second receive performance metric of the second radio chain of the UE; and
determining a difference between the first receive performance metric and the second receive performance metric.

12-18. (canceled)

19. An apparatus comprising:
a first radio chain coupled to a first antenna port;
a second radio chain coupled to a second antenna port; and
a wireless transceiver coupled to the first radio chain and the second radio chain, the wireless transceiver configured to:
generate a set of sounding reference signal (SRS) symbols that include at least a first SRS symbol and a second SRS symbol;
determine, for the second SRS symbol, an offset based on a difference between the first radio chain and the second radio chain;
map the first SRS symbol to the first antenna port of the first radio chain;
map the second SRS symbol to the first antenna port of the first radio chain;
transmit, to a base station, the first SRS symbol via the antenna port of the first radio chain;
apply the offset for the second SRS symbol to the first radio chain;
transmit, to the base station, the second SRS symbol via the antenna port of the first radio chain with the offset applied to the first radio chain; and
communicate with the base station based on channel state information determined using at least the first SRS symbol and the second SRS symbol.

20. The apparatus as recited by claim 19, wherein:
the first radio chain is configured for transmitting uplink communications and receiving downlink communications; and
the second radio chain is configured for receiving downlink communications.

21. The apparatus as recited by claim 19, wherein the wireless transceiver is further configured to:
receive, from the base station, a request to implement a channel sounding procedure by:
transmitting the first SRS symbol via a first antenna of the apparatus; and
transmitting the second SRS symbol via a second antenna of the apparatus.

22. The apparatus as recited by claim 21, wherein a hardware configuration of the apparatus is not capable of implementing a one transmit chain to four receive chain (1T4R) or a two transmit chain to four receive chain (2T4R) channel sounding procedure, and the request to implement the channel sounding procedure requests that the apparatus perform the channel sounding procedure by using one of:
1T4R antenna switching; or
2T4R antenna switching.

23. The apparatus as recited by claim 19, wherein the wireless transceiver is further configured to:
determine the offset based on a difference in receive performance between the first radio chain and the second radio chain of the apparatus; or
determine the offset as a transmitter gain adjustment for the first radio chain such that performance of the first radio chain approximates performance of the second radio chain.

24. A system-on-chip comprising:
a transceiver module that includes a transmitter module and a receiver module, the transceiver module configured to generate a set of sounding reference signal (SRS) symbols that include at least a first SRS symbol and a second SRS symbol;
a first interface to a first radio chain capable of transmit and receive operations;
a second interface to a second radio chain capable of receive operations;
an SRS mapping module configured to:
determine, for the second SRS symbol, an offset based on a difference between the first radio chain and the second radio chain;
map the first SRS symbol to a first antenna port of the first radio chain;
map the second SRS symbol to the first antenna port of the first radio chain;
direct the transceiver module to transmit, to a base station, the first SRS symbol via the first antenna port of the first radio chain;
apply the offset for the second SRS symbol to the first radio chain;
direct the transceiver module to transmit, to the base station, the second SRS symbol via the first antenna port of the first radio chain with the offset applied to the first radio chain; and
direct the transceiver module to communicate with the base station based on channel state information determined using at least the first SRS symbol and the second SRS symbol.

25. The system-on-chip as recited by claim 24, wherein the transceiver module is further configured to:
receive, from the base station, a request to implement a channel sounding procedure by:
transmitting the first SRS symbol via a first antenna coupled to the first radio chain; and
transmitting the second SRS symbol via a second antenna coupled to the second radio chain.

26. The system-on-chip as recited by claim 25, wherein:
the system-on-chip further comprises a third interface to a third radio chain and a fourth interface to a fourth radio chain;
the transceiver module is not capable of implementing a one transmit chain to four receive chain (1T4R) or a two transmit chain to four receive chain (2T4R) channel sounding procedure, and the request to implement the channel sounding procedure requests that the transceiver module perform the channel sounding procedure by using one of:
1T4R antenna switching; or
2T4R antenna switching.

27. The system-on-chip as recited by claim 26, wherein the transceiver module is further configured to indicate to the base station that the transceiver module is capable of implementing the 1T4R antenna switching or the 2T4R antenna switching.

28. The system-on-chip as recited by claim 24, wherein the SRS mapping module is further configured to:
determine the offset based on a difference in receive performance between the first radio chain and the second radio chain of the transceiver module; or
determine the offset as a transmitter gain adjustment for the first radio chain such that performance of the first radio chain approximates performance of the second radio chain.
